(19) United States
(12) Patent Application Publication
(10) Pub. No.: US 2025/0199132 A1
(43) Pub. Date: Jun. 19, 2025

(54) AMPLIFICATION OF SIGNALS IN IMAGING SYSTEMS

(71) Applicant: SiLC Technologies, Inc., Monrovia, CA (US)

(72) Inventors: Mehdi Asghari, La Canada Flintridge, CA (US); Amir Ali Tavallaee, San Francisco, CA (US); Nirmal Warke, Saratoga, CA (US)

(21) Appl. No.: 18/539,251

(22) Filed: Dec. 13, 2023

(51) Int. Cl. G01S 7/481; G01S 7/4861; G01S 17/89

(52) U.S. Cl. CPC G01S 7/4818; G01S 7/4817; G01S 7/4861; G01S 17/89

(57) ABSTRACT

A LIDAR system includes a utility waveguide that guides an outgoing LIDAR signal precursor. The LIDAR system also includes multiple preliminary alternate waveguides that each guides a preliminary outgoing LIDAR signal that includes light from the outgoing LIDAR signal precursor. The LIDAR system includes amplifiers that are each configured to receive one of the preliminary outgoing LIDAR signals from a different one of the preliminary alternate waveguides. Each of the amplifiers outputs an outgoing LIDAR signal that includes light from one of the preliminary outgoing LIDAR signals. The LIDAR system includes multiple alternate waveguides that each receives one of the outgoing LIDAR signals from a different one of the amplifiers. Electronics operate the amplifiers such that one of the amplifiers serve as an active amplifier and one or more of the amplifiers each serves as inactive amplifier. The outgoing LIDAR signal output from the active amplifier is an active outgoing LIDAR signal and any outgoing LIDAR signal output from one of the inactive amplifiers is an inactive outgoing LIDAR signal. The LIDAR system uses light output from the active outgoing LIDAR signal to calculate LIDAR data but does not use light output from the inactive amplifiers to calculate any LIDAR data. The LIDAR data indicates a distance and/or radial velocity between the LIDAR system and an object.

### FIELD

The invention relates to imaging. In particular, the invention relates to LIDAR systems.

### BACKGROUND

Imaging systems such as LIDAR systems are being used in an increasing number of applications. LIDAR systems output a system output signal that is scanned across the field of view for the LIDAR system. An object in the field of view reflects the system output signal. A portion of the reflected system output signal returns to the LIDAR systems as a system return signal. The LIDAR system uses light from the system return signal to generate LIDAR data that indicates the distance and/or radial velocity between the LIDAR system and the object.

Many LIDAR systems have a signal director that receives an outgoing light signal from a waveguide and then directs the outgoing light signal to an alternate waveguide selected from among several alternate waveguides. The LIDAR system can include electronics that operate the signal selector so as to select which one of the alternate waveguides receives the outgoing light signal. The system output signal includes light from the outgoing light signal and a direction that the system output signal travels away from the LIDAR system changes in response to changes in the alternate waveguides that receives the outgoing light signal. As a result, the system output signal can be scanned within the field of view by changing the alternate waveguides the receives the outgoing light signal. However, the signal selector is a source of optical loss in the LIDAR system. As a result, there is a need for a LIDAR system with reduced optical loss.

### SUMMARY

A LIDAR system includes a utility waveguide that guides an outgoing LIDAR signal precursor. The LIDAR system also includes multiple preliminary alternate waveguides that each guides a preliminary outgoing LIDAR signal that includes light from the outgoing LIDAR signal precursor. The LIDAR system includes amplifiers that are each configured to receive one of the preliminary outgoing LIDAR signals from a different one of the preliminary alternate waveguides. Each of the amplifiers outputs an outgoing LIDAR signal that includes light from one of the preliminary outgoing LIDAR signals. The LIDAR system includes multiple alternate waveguides that each receives one of the outgoing LIDAR signals from a different one of the amplifiers. Electronics operate the amplifiers such that one of the amplifiers serves as an active amplifier and one or more of the amplifiers each serves as inactive amplifier. The outgoing LIDAR signal output from the active amplifier is an active outgoing LIDAR signal and any outgoing LIDAR signal output from one of the inactive amplifiers is an inactive outgoing LIDAR signal. The LIDAR system uses light output from the active outgoing LIDAR signal to calculate LIDAR data but does not use light output from the inactive amplifiers to calculate any LIDAR data. The LIDAR data indicates a distance and/or radial velocity between the LIDAR system and an object.

A LIDAR system includes a utility waveguide that guides an outgoing LIDAR signal precursor. The LIDAR system also includes multiple preliminary alternate waveguides that each guides a preliminary outgoing LIDAR signal that includes light from the outgoing LIDAR signal precursor. The LIDAR system includes amplifiers that are each configured to receive one of the preliminary outgoing LIDAR signals from a different one of the preliminary alternate waveguides. Each of the amplifiers outputs an outgoing LIDAR signal that includes light from one of the preliminary outgoing LIDAR signals. The LIDAR system includes multiple alternate waveguides that each receives one of the outgoing LIDAR signals from a different one of the amplifiers. Electronics operate the amplifiers such that one of the amplifiers serves as an active amplifier and one or more of the amplifiers each serves as inactive amplifier. The outgoing LIDAR signal output from the active amplifier is an active outgoing LIDAR signal and any outgoing LIDAR signal output from one of the inactive amplifiers is an inactive outgoing LIDAR signal. The LIDAR system is configured to transmit a system output signal that includes light from the active outgoing LIDAR signal. The direction that the system output signal travels away from the LIDAR system changes in response to a change in the amplifier that serves as the active amplifier.

A method of operating a LIDAR system includes splitting an outgoing LIDAR signal precursor into preliminary outgoing LIDAR signals. The method also includes receiving the preliminary outgoing LIDAR signals at amplifiers and outputting from each of the amplifiers an outgoing LIDAR signal. Each of the outgoing LIDAR signals includes light from one of the preliminary outgoing LIDAR signals. The method further includes operating the amplifiers such that one of the amplifiers serves as an active amplifier and a portion of the amplifiers each serves as an inactive amplifier. The outgoing LIDAR signal output from the active amplifier is an active outgoing LIDAR signal and any outgoing LIDAR signal output from one of the inactive amplifiers is an inactive outgoing LIDAR signal. The method further includes using light output from the active outgoing LIDAR signal to calculate LIDAR data without using light output from the inactive amplifiers to calculate any LIDAR data, the LIDAR data indicating a distance and/or radial velocity between the LIDAR system and an object.

A method of operating a LIDAR system includes splitting an outgoing LIDAR signal precursor into preliminary outgoing LIDAR signals. The method also includes receiving the preliminary outgoing LIDAR signals at amplifiers and outputting from each of the amplifiers an outgoing LIDAR signal. Each of the outgoing LIDAR signals includes light from one of the preliminary outgoing LIDAR signals. The method further includes operating the amplifiers such that one of the amplifiers serves as an active amplifier and a portion of the amplifiers each serves as an inactive amplifier. The outgoing LIDAR signal output from the active amplifier is an active outgoing LIDAR signal and any outgoing LIDAR signal output from one of the inactive amplifiers is an inactive outgoing LIDAR signal. The method also includes transmitting from the LIAR system a system output signal that includes light from the active outgoing LIDAR signal. The method further includes changing the amplifier that serves as the active amplifier. The direction that the system output signal travels away from the LIDAR system changes in response to the change in the amplifier that serves as the active amplifier.

### BRIEF DESCRIPTION OF THE FIGURES

FIG. 1A illustrates an imaging system that includes a chip with a photonic circuit.

FIG. 1B illustrates another embodiment of an imaging system that includes a chip with a photonic circuit.

FIG. 2 is a schematic of a LIDAR system that includes multiple different cores on a chip.

FIG. 3 is a schematic of a LIDAR system that includes multiple different cores on a chip.

FIG. 4A is a schematic of a LIDAR system constructed according to FIG. 2 where the chip has an array of alternate waveguide facets with a varying separation distance between the facets.

FIG. 4B is a schematic of the LIDAR system of FIG. 4A after a change in the wavelength of the system output signal.

FIG. 4C is a schematic of the relationship between the LIDAR system shown in FIG. 4A and the field of view for the LIDAR system.

FIG. 4D is a sideview of the field of view of a LIDAR system at the maximum operational distance of the LIDAR system.

FIG. 4E is the sideview shown in FIG. 4D after shifting of system output signals within the field of view.

FIG. 5A through FIG. 5B illustrates an example of a light signal processor that is suitable for use as the light signal processor in a LIDAR system constructed according to FIG. 1A. FIG. 5A is a schematic of an example of a suitable optical-to-electrical assembly for use in the light signal processor.

FIG. 5B provides a schematic of the relationship between electronics and the optical-to-electrical assembly of FIG. 5A.

FIG. 5C illustrates an example of the frequency versus time pattern for a system output signal transmitted from the imaging system.

FIG. 6 is a cross section of a silicon-on-insulator wafer.

FIG. 7A is schematic of an example of a suitable signal selector having a light signal splitter and amplifiers.

FIG. 7B is schematic of another example of a suitable signal selector.

FIG. 7C is schematic of another example of a suitable signal selector.

FIG. 8A is a topview of a portion of a LIDAR chip that includes an interface for optically coupling the LIDAR chip with a signal selector.

FIG. 8B is a perspective view of a portion of the LIDAR chip shown in FIG. 8A.

FIG. 8C is a perspective view of an amplifier chip suitable for use with the portion of the LIDAR chip shown in FIG. 8A and FIG. 8B.

FIG. 8D and FIG. 8E illustrate a LIDAR system that includes the LIDAR chip of FIG. 8A and FIG. 8B interfaced with the signal selector of FIG. 8C. FIG. 8D is a topview of the system.

FIG. 8E is a cross section of the system shown in FIG. 8D taken along a line extending between the brackets labeled E in FIG. 8D.

### DESCRIPTION

The LIDAR system has a signal selector that receives an outgoing LIDAR signal precursor. The signal selector divides the outgoing LIDAR signal precursor into multiple preliminary outgoing LIDAR signals that are each received at a different amplifier. The amplifiers are each configured to output an outgoing LIDAR signal that includes light from one of the preliminary outgoing LIDAR signals. The LIDAR system includes electronics that operate the amplifiers such that one or more of the amplifiers each serves as an active amplifier and the remaining amplifiers are each an inactive amplifier.

The LIDAR system transmits a system output signal that includes light from the outgoing LIDAR signal output from the amplifier that is currently the active amplifier. The electronics can operate the amplifiers so as to change the amplifier that serves as the active amplifier. The direction that the system output signal travels away from the LIDAR system changes in response to changes in the amplifier that serves as the active amplifier. As a result, the system output signal can be scanned across different sample regions in a field of view by changing the amplifier that serves as the active amplifier. Because the active amplifier amplifies the power of the light included in the system output signal, the active amplifier amplifies the system output signal and compensates for the optical loss that is normally associated with scanning a system output signal.

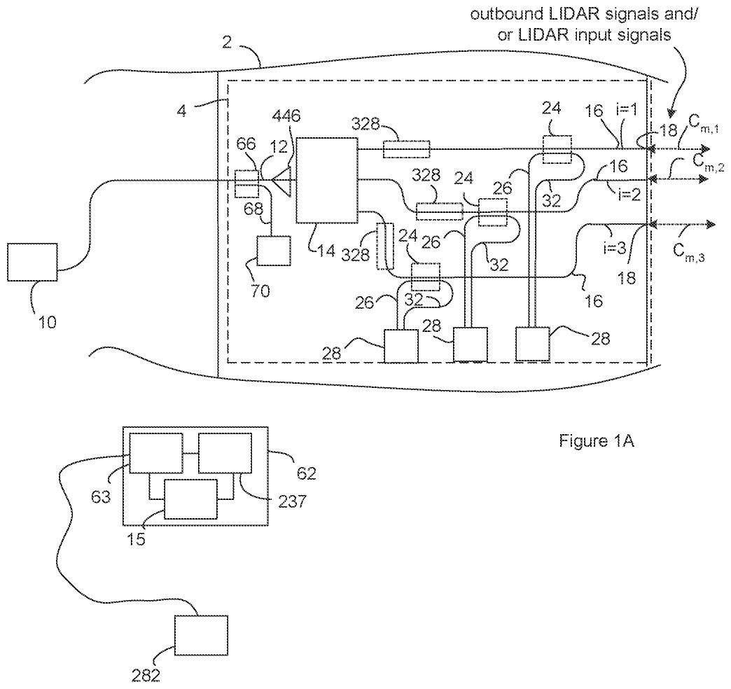

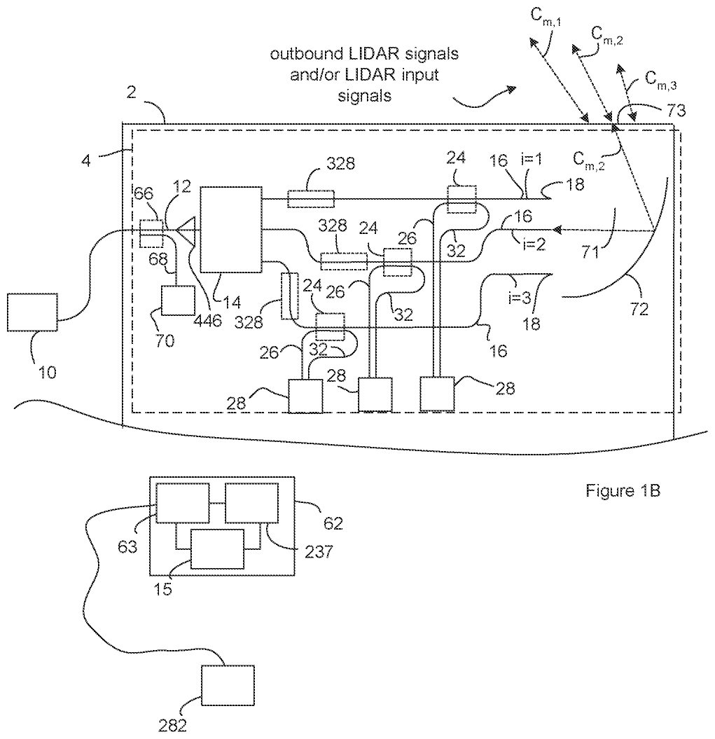

FIG. 1A is a schematic of a portion of a LIDAR system that includes a LIDAR chip. FIG. 1A includes a topview of a portion of the LIDAR chip 2. The LIDAR chip includes a LIDAR core 4. The LIDAR system also includes a light source 10 and electronics 62. The light source 10 outputs an outgoing LIDAR signal precursor that can carry one of M different wavelength channels. There are M wavelength channels and each of the wavelength channels is associated with a wavelength channel index m where m has a value from 1 to M. Each of the M wavelength channels is at a different wavelength. The electronics 62 can operate the light source 10 so as to select which of the M different wavelength channels is carried by the outgoing LIDAR signal precursor and can switch the selection of the M different wavelength channels that are carried by the outgoing LIDAR signal precursor. In some instances, the electronics 62 operate the light source 10 such that the outgoing LIDAR signal precursor carries one, or substantially one, wavelength channel at a time. Suitable values for M include, but are not limited to, values greater than or equal to 2, 4, 8, or 16 and less than 32, 64, or 128. In some instances, the separation between adjacent wavelength channels is greater than 0.4 nm, 0.8 nm, or 1.2 nm and/or less than 5 nm, 10 nm, or 20 nm.

The LIDAR core 4 includes a photonic integrated circuit with a utility waveguide 12. The utility waveguide 12 receives the outgoing LIDAR signal precursor from the light source 10. The utility waveguide 12 carries the outgoing LIDAR signal precursor to a signal selector 14. The LIDAR system can include electronics 62 that operate the signal selector 14. For instance, the electronics 62 can include a selector controller 15 that operates the signal selector 14 such that the signal selector 14 outputs one or more active outgoing LIDAR signals that each includes, consists of, or consists essentially of light from the outgoing LIDAR signal precursor received by the signal selector 14. In some instances, the selector controller 15 operates the signal selector 14 such that the signal selector 14 outputs one active outgoing LIDAR signal. Each of the active outgoing LIDAR signals output by the signal selector 14 is received by a different one of multiple different alternate waveguides 16. There are N alternate waveguides and each of the alternate waveguides 16 is associated with an alternate waveguide index i where i has a value from 1 to N. Suitable values of N include, but are not limited to, values less than 128, 64, or 32 and/or greater than 2, 8, or 16. In one example, N is between 2 and 128.

Over time, each of the alternate waveguides 16 can receive an active outgoing LIDAR signal from the signal selector 14, however, the electronics can select which of the alternate waveguides receives the active outgoing LIDAR signal and can tune the selection of alternate waveguides that receive the active outgoing LIDAR signal. The alternate waveguide 16 receiving the active outgoing LIDAR signal serves as an active waveguide. Each of the alternate waveguides 16 that is not receiving an active outgoing LIDAR signal serves as an inactive active waveguide. The active waveguide carries the active outgoing LIDAR signal to a port 18 through which the active outgoing LIDAR signal can exit from the LIDAR chip and serve as an outbound LIDAR signal. In some instances, the alternate waveguides 16 terminate at a facet that serves as the port 18. Accordingly, the active outgoing LIDAR signal is output from the active waveguide.

The light signals that result from the active outgoing LIDAR signal being received by the alternate waveguide 16 with alternate waveguide index i can be classified as light signals carrying channel (C_{m,i}) where m is the wavelength channel index and i is the alternate waveguide index. Accordingly, a light signal output from alternate waveguide index i and carrying wavelength channel m is carrying channel (C_{m,i}). As an example, the path of the outbound LIDAR signal that carries the channel with alternate waveguide index 2 is labeled C_{1-M,2} in FIG. 1A. For the purposes of illustration, the LIDAR system is shown as generating three outbound LIDAR signals (i=3) labeled C_{m,1} through C_{m,3}. Each of the illustrated outbound LIDAR signals can carry all or a portion of the wavelength channels m=1 through M.

A LIDAR input signal returns to the LIDAR chip such that a LIDAR input signal carrying channel C_{m,i} enters the alternate waveguide 16 that is associated with the same alternate waveguide index i. As a result, LIDAR input signals carrying channels with different alternate waveguide indices are received at different alternate waveguides. The portion of the LIDAR input signal that enters an alternate waveguide 16 serves as an incoming LIDAR signal. As a result, the alternate waveguide 16 that receives the incoming LIDAR signal can guide an active outgoing LIDAR signal while also guiding the incoming LIDAR signal in the opposite direction. Accordingly, the LIDAR system can be a monostatic system. The alternate waveguide 16 that receives the incoming LIDAR signal carries the incoming LIDAR signal to the signal selector 14. The signal selector 14 outputs the incoming LIDAR signal on the utility waveguide 12.

The alternate waveguide 16 that receives the incoming LIDAR signal carries the incoming LIDAR signal to a 2×2 splitter 24 that moves a portion of the incoming LIDAR signal from the alternate waveguide 16 onto a comparative waveguide 26 as a comparative signal. The comparative signal includes light from the active outgoing LIDAR signal that has exited from the imaging system, that has been reflected by an object located outside of the imaging system, and that has returned to the imaging system. The comparative waveguide 26 carries the comparative signal to a signal processor 28 for further processing. Suitable splitters 24 include, but are not limited to, optical couplers, Y-junctions, and MMIs. In some instances, the splitter 24 is configured such that the power of the incoming LIDAR signal is divided evenly or substantially evenly between the utility waveguide 12 and the comparative waveguide 26.

The alternate waveguide 16 that receives the incoming LIDAR signal also carries the active outgoing LIDAR signal to the splitter 24. The splitter 24 moves a portion of the active outgoing LIDAR signal from the alternate waveguide 16 onto a reference waveguide 32 as a reference signal. The reference waveguide 32 carries the reference signal to the signal processor 28 for further processing. Although not illustrated, a signal power reducer can optionally be positioned along the reference waveguide 32 to reduce the power of the reference signal to reduce or prevent saturation of one or more light sensor included in the signal processor 28. Examples of suitable signal power reducers include, but are not limited to, attenuators including variable optic attenuators (VOAs) and light splitters combined with beam dumps.

As will be described in more detail below, the signal processor 28 combines the comparative signal with the reference signal to form a composite signal that carries LIDAR data for a sample region on the field of view. Accordingly, the composite signal can be processed so as to extract LIDAR data (radial velocity and/or distance between a LIDAR system and an object external to the LIDAR system) for the sample region.

The electronics 62 can include a light source controller 63. The light source controller 63 can operate the light source such that the outgoing LIDAR signal precursor, the resulting active outgoing LIDAR signal, and the resulting system output signal, have a particular frequency versus time pattern. For instance, the light source controller 63 can operate the light source such that the outgoing LIDAR signal precursor, the resulting active outgoing LIDAR signal, and the resulting system output signal, have different chirp rates during different data periods. Additionally, or alternately, the light source controller 63 can operate the light source such that the outgoing LIDAR signal precursor, the resulting active outgoing LIDAR signal, and the resulting system output signal, carry the wavelength channel that is currently desired for operation of the LIDAR system.

The LIDAR chip can optionally include a control branch for controlling the operation of the light source 10. For instance, the control branch can provide a feedback loop that the light source controller 63 uses in operating the light source such that the outgoing LIDAR signal precursor, the resulting active outgoing LIDAR signal, and the resulting system output signal have the desired frequency versus time pattern.

The control branch includes a directional coupler 66 that moves a portion of the outgoing LIDAR signal precursor from the utility waveguide 12 onto a control waveguide 68. The coupled portion of the outgoing LIDAR signal precursor serves as a tapped signal. Although FIG. 1A illustrates a directional coupler 66 moving the portion of the outgoing LIDAR signal precursor onto the control waveguide 68, other signal-taps can be used to move a portion of the outgoing LIDAR signal precursor from the utility waveguide 12 onto the control waveguide 68. Examples of suitable signal taps include, but are not limited to, Y-junctions, and MMIs.

The control waveguide 68 carries the tapped signal to a feedback system 70. The feedback system 70 can include one or more light sensors (not shown) that convert light signals carried by the feedback system 70 to electrical signals that are output from the feedback system 70. The light source controller 63 can receive the electrical signals output from the feedback system 70. During operation, the light source controller 63 can adjust the frequency of the outgoing LIDAR signal precursor in response to output from the electrical signals output from the feedback system 70. An example of a suitable construction and operation of feedback system 70 and light source controller 63 is provided in U.S. patent application Ser. No. 16/875,987, filed on 16 May 2020, entitled “Monitoring Signal Chirp in outbound LIDAR signals,” and incorporated herein in its entirety; and also in U.S. patent application Ser. No. 17/244,869, filed on 29 Apr. 2021, entitled “Reducing Size of LIDAR System Control Assemblies,” and incorporated herein in its entirety.

Although FIG. 1A illustrates the electronics 62 as a component that is separate from the signal processor(s) 28, a portion of the electronics 62 can be included in each of the signal processor(s) 28.

The portion of the LIDAR system illustrated in FIG. 1A can be modified to include a reflecting surface 72 that receives the outgoing LIDAR signals. For instance, FIG. 1B illustrates the LIDAR chip in the LIDAR system of FIG. 1A modified to include a free space region 71 that extends from the reflecting surface 72 to a facet 73 at the lateral side of the LIDAR chip and from the reflecting surface 72 to the alternate waveguides 16. As illustrated by the outgoing LIDAR signal labeled C_{m,2}, the outgoing LIDAR signals travel through the free space region 71 between the alternate waveguides 16 and the reflecting surface 72 and/or between the reflecting surface 72 and a facet 73 at the lateral side of the LIDAR chip. For instance, the outgoing LIDAR signals can travel from the alternate waveguides 16, through the free space region 71 to the reflecting surface 72 and then from the reflecting surface 72 to the facet 73 at the lateral side of the LIDAR chip. The outgoing LIDAR signals can exit the LIDAR chip through the facet 73 at the lateral side of the LIDAR chip. The portion of each outgoing LIDAR signal that exits the LIDAR chip through the facet 73 can serve as an outbound LIDAR signal. The reflecting surface is configured such that the LIDAR output signals travel away from the semiconductor chip in different directions. Additionally or alternately, the incoming LIDAR signals also travel through the free space region 71 between the alternate waveguides 16 and the reflecting surface 72 and/or between the reflecting surface 72 and a facet 73 at the lateral side of the LIDAR chip. For instance, the incoming LIDAR signals can travel from the facet 73 at the lateral side of the LIDAR chip, through the free space region 71 to the reflecting surface 72, and then from reflecting surface 72 and then from the reflecting surface 72 to the alternate waveguides 16. The free space region 71 is free space in the horizontal direction but guided in the vertical direction and can accordingly be considered a partially free space region 71. For instance, the free space region 71 can be a slab waveguide. As a result, the outgoing LIDAR signals and/or the incoming LIDAR signals can contract or expand horizontally when traveling through the partial free space region 71.

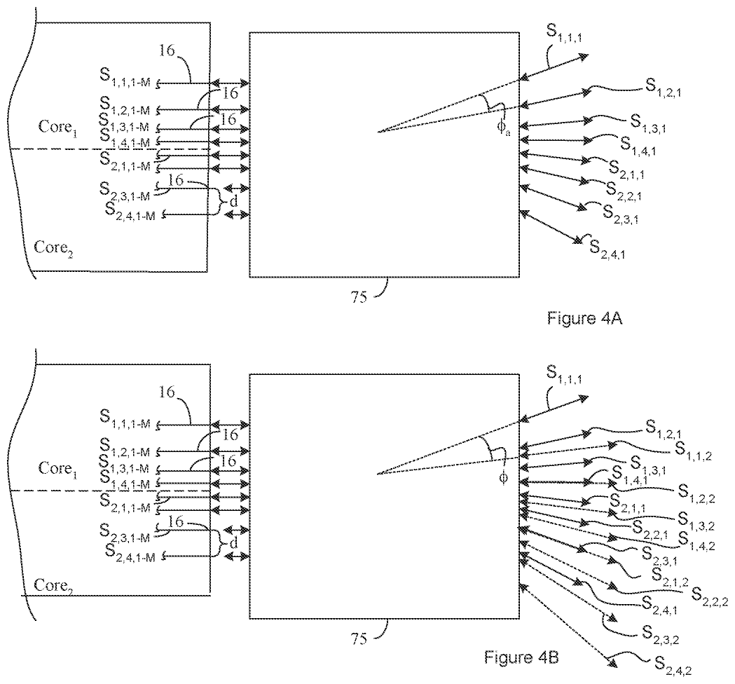

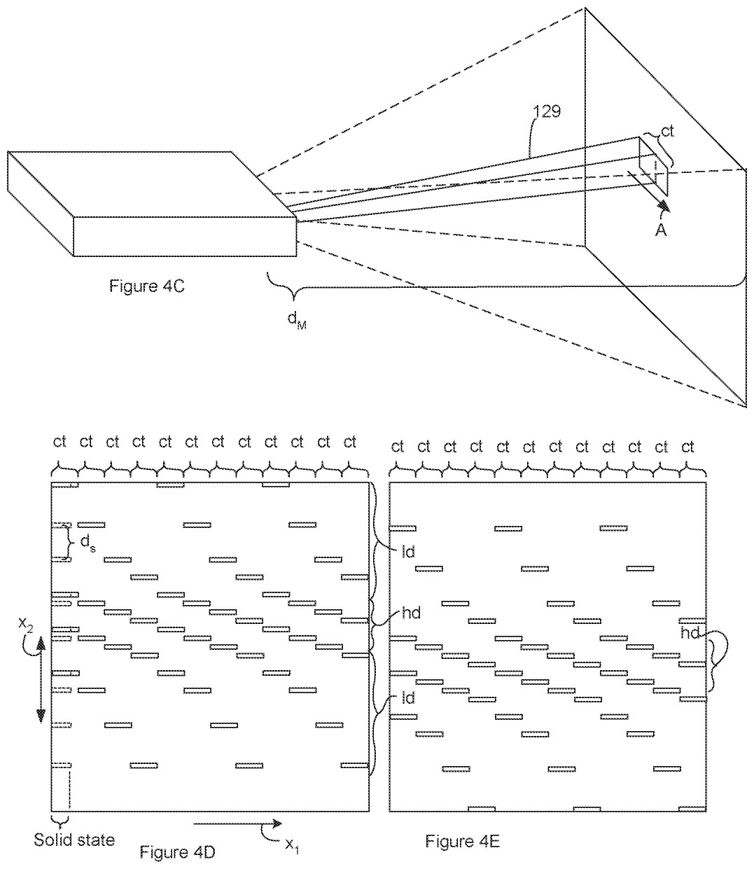

In some instances, the shape of the reflecting surface 72 is selected to provide collimation or focusing of the outgoing LIDAR signals and accordingly of the resulting outbound LIDAR signals. The collimation provided by the reflecting surface 72 can be in collimation can be in a plane that is parallel to a plane of the LIDAR chip as shown in FIG. 4A without providing substantial collimation within a plane perpendicular to the plane of the LIDAR chip. Additionally or alternately, the shape of the reflecting surface 72 can be selected to focus the incoming LIDAR signals on the alternate waveguides 16. The focus provided by the reflecting surface 72 can be in collimation can be in a plane that is parallel to a first plane without providing substantial collimation within a second plane that is perpendicular to the first plane. The first plane can be the plane of the LIDAR chip. An example of the plane of the LIDAR chip can be the bottom of the LIDAR chip or other surface of the LIDAR chip that is considered or approximates a horizontal surface.

In some instances, the reflecting surface 71 is a smooth and curved surface that acts as a mirror. In some instances, the reflecting surface 71 is configured as a reflective optical grating such an echelle grating. In one example, the reflecting surface 71 is parabolic, spherical, or aspherical and can be optimized to achieve the desired light throughput. In one example, the reflecting surface 71 is substantially parabolic or approximately parabolic. The interface between the free space region 71, the alternate waveguides 16, the reflecting surface 72 and the facet 73 can be constructed and as disclosed in U.S. patent application Ser. No. 18/383,037, filed on Oct. 23, 2023, entitled “Return Surfaces in LIDAR Systems,” and incorporated herein in its entirety.

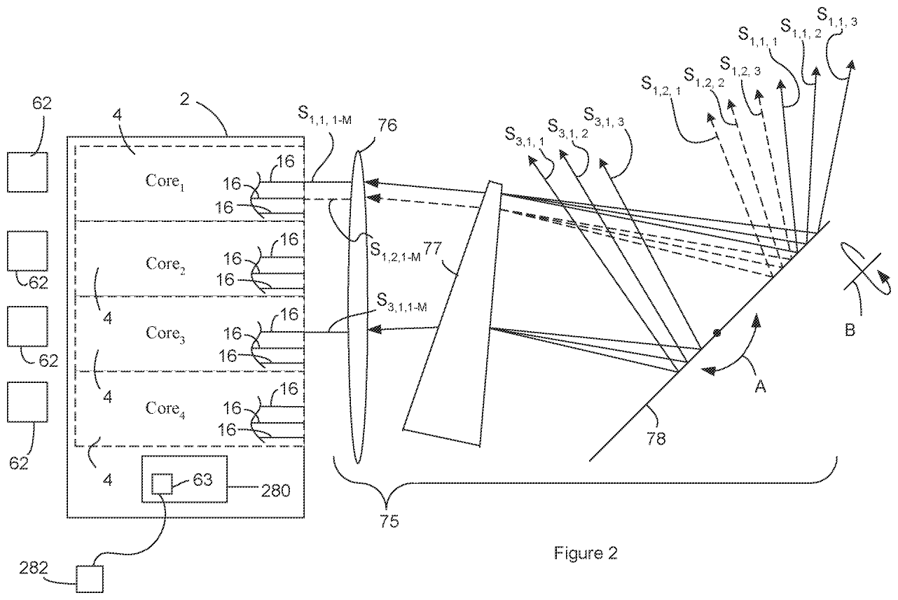

A LIDAR system can include a LIDAR chip with one or more LIDAR cores 4. As an example, FIG. 2 illustrates a LIDAR chip that includes multiple different cores. Although the core in FIG. 2 are illustrated as being constructed according to FIG. 1A, all or a portion of the cores can be constructed according to FIG. 1B. The cores are each labeled coreₖ where k represents a core index k with a value from 1 to K. Each of the LIDAR cores can be constructed as disclosed in the context of FIG. 1A or can have an alternate construction. Each of the LIDAR cores outputs a different outbound LIDAR signal. The outbound LIDAR signal output from the core labeled coreₖ carries LIDAR channel S_{k,i,m} where k represents the core index, m represents the wavelength channel index, and i represents the alternate waveguide index. As a result, LIDAR channel S_{k,i,m} is function of the wavelength channel index m, alternate waveguide index i and the core index k. As an example, the outbound LIDAR signal carrying LIDAR channel S_{k,i,m} is output from coreₖ, carries wavelength channel m, and includes light that was received by alternate waveguide index i and output from alternate waveguide index i. Accordingly, the outbound LIDAR signal carrying LIDAR channel S_{k,i,m} is output from coreₖ and carries channel C_{m,i}. As an example, an outbound LIDAR signal output from core k=1 and carrying light from an active outgoing LIDAR signal received at alternate waveguide i=1 carries the LIDAR channels labeled S_{1,1,1-M} in FIG. 2. In contrast, an outbound LIDAR signal output from core k=1 and carrying light from alternate waveguide i=2 carries the LIDAR channels labeled S_{1,2,1-M} in FIG. 2. The outbound LIDAR signals labeled S_{1,1,1-M} are shown as spaced apart from the outbound LIDAR signals labeled S_{1,2,1-M} as a result of the spatial separation between the facets of the different alternate waveguides. In the labels S_{1,1,1-M} and S_{1,2,1-M} the variable 1-M represent 1 through M and accordingly indicates that each of the different wavelength channels (1-M) travels the labeled portion of the pathway. For instance, each of the different wavelength channels 1-M that are output from core k=1 while carrying light from an active outgoing LIDAR signal received at alternate waveguide i=2 travels the portion of the optical pathway labeled S_{1,2,1-M} in FIG. 2.

The LIDAR system can include an optical component assembly 75 that receives the outbound LIDAR signal from each of the different cores and outputs system output signals that each includes, consists of, or consists essentially of light from a different one of the outbound LIDAR signals. When the optical assembly includes active components such as movable mirrors, the active components can be operated by assembly electronics 280 so as to steer the system output signals to different sample regions in the LIDAR system's field of view.

FIG. 2 illustrates an optical component assembly 75 that optionally includes a signal director 76 that receives the outbound LIDAR signal from different cores. The signal director 76 changes the direction that at least a portion of the outbound LIDAR signals are traveling. Suitable signal directors 76 include, but are not limited to, lenses such as convex lenses, mirrors such as concave mirrors and combinations of these elements. When the LIDAR chip is constructed according to FIG. 1B, signal director 76 can be a cylindrical lens. A cylindrical lens is configured to focus collimated light signals into a line rather than the focal point provided by a spherical lens. As a result, a signal director 76 can provide collimation of the outbound LIDAR signals in a second plane that is perpendicular to the first plane without providing substantial collimation within the first plane. For instance, the signal director 76 can provide collimation in a second plane that is perpendicular to the plane of the LIDAR chip without providing substantial collimation within a plane parallel to the plane of the LIDAR chip.

The optical assembly illustrated in FIG. 2 also includes a wavelength chromatic disperser 77 that receives the outbound LIDAR signals. In some instances, the wavelength chromatic disperser 77 receives all or a portion of the outbound LIDAR signals from a signal director 76, from all or a portion of the LIDAR cores, or from other optical component(s) depending on the configuration of the optical component assembly 75. The wavelength chromatic disperser 77 is configured to cause chromatic dispersion such that direction that an outbound LIDAR signal travels away from the wavelength chromatic disperser 77 is a function of the wavelength channel carried by the outbound LIDAR signal. For instance, the direction that an outbound LIDAR signal travels away from the wavelength chromatic disperser 77 changes in response to changes in the wavelength channel carried by the outbound LIDAR signal. As an example, the outbound LIDAR signals carrying the LIDAR channels labeled S_{1,2,1-M} in FIG. 2 are each received at the same location or substantially the same location on the wavelength chromatic disperser 77. The wavelength chromatic disperser 77 directs each of the outbound LIDAR signals such that when the outbound LIDAR signal carries different LIDAR channels, the outbound LIDAR signal travels away from the wavelength chromatic disperser 77 in different directions. For instance, the outbound LIDAR signal labeled S_{1,2,1-M} can carry any of the wavelength channels m=1 through M. In particular, the outbound LIDAR signal labeled S_{1,2,1-M} can carry the LIDAR channel S_{1,2,1}, S_{1,2,2}, or S_{1,2,3}. As shown in FIG. 2, the wavelength chromatic disperser 77 operates on the outbound LIDAR signal labeled S_{1,2,1-M} such that the direction that the outbound LIDAR signal travels away from the LIDAR system changes depending on whether the outbound LIDAR signal is carrying LIDAR channel S_{1,2,1}, S_{1,2,2}, or S_{1,2,3}. As a result, the electronics can scan each of the outbound LIDAR signals to different sample regions in a field of view by changing the wavelength channel carried by the outbound LIDAR signal.

In some instances, the optical component assembly 75 is configured such that changing the wavelength channel carried by an outbound LIDAR signal does not change, or does not substantially change, the location on the wavelength chromatic disperser 77 where the outbound LIDAR signal is received. Depending on the configuration of the wavelength chromatic disperser 77, an outbound LIDAR signal carrying different wavelength channels can exit from the wavelength chromatic disperser 77 at the same or substantially the same location or can exit from the wavelength chromatic disperser 77 from different locations.

Suitable wavelength chromatic dispersers 77 can include or consist of one or more dispersive media and/or have a wavelength dependent refractive index. Examples of suitable wavelength chromatic dispersers 77 include, but are not limited to, reflective diffraction gratings, transmissive diffraction gratings, and prisms. In some instances, the wavelength chromatic disperser 77 is configured to provide a level of dispersion greater than 0.005°/nm, 0.05°/nm, 0.1°/nm, or 0.2°/nm and less than 0.3°/nm, 0.4°/nm, or 0.5°/nm. The wavelength chromatic disperser 77 is optional. In instances where a single wavelength channel (M=1) is used, the wavelength chromatic disperser 77 may not be present.

The electronics can scan each of the outbound LIDAR signals to different sample regions in the field of view by changing the alternate waveguide that receives the active outgoing LIDAR signal. For instance, FIG. 2 illustrates an outbound LIDAR signal that carries LIDAR channels labeled S_{1,1,1-M} and LIDAR channels labeled S_{1,2,1-M}. When the outbound LIDAR signal carries LIDAR channels S_{1,1,1-M}, the outbound LIDAR signal is output from the alternate waveguide with alternate waveguide index i=1 on the core with core index k=1. In contrast, when the outbound LIDAR signal carries LIDAR channels S_{1,2,1-M}, the outbound LIDAR signal is output from the alternate waveguide with alternate waveguide index i=2 on the core with core index k=1. As a result, the outbound LIDAR signal is output from different alternate waveguides on the same core. As is evident from comparing the direction that the outbound LIDAR signal (system output signal) travels away from the LIDAR system when carrying LIDAR channels S_{1,1,1-M} to the direction that the outbound LIDAR signal travels away from the LIDAR system when carrying LIDAR channels LIDAR channels S_{1,2,1-M}, the change in the alternate waveguide that receives the active outgoing LIDAR signal causes a change in the direction that the outbound LIDAR signal and the resulting system output signal travel away from the LIDAR system. FIG. 2 also illustrates that the change in direction occurs when the outbound LIDAR signal carries the same wavelength channel during the change in alternate waveguide and/or when the outbound LIDAR signal carries different wavelength channels during the change in alternate waveguide. As a result, the electronics can scan each of the outbound LIDAR signals to different sample regions in a field of view by changing the alternate waveguide from which the outbound LIDAR signal originates. For instance, the electronics can scan the system output signal to different sample regions in a field of view by changing the alternate waveguide from which the outbound LIDAR signal originates.

FIG. 2 also illustrates that the outbound LIDAR signals from different cores travel away from the LIDAR system in different directions. For instance, FIG. 2 illustrates an outbound LIDAR signal that carries LIDAR channels labeled S_{1,1,1-M} and an outbound LIDAR signal that carries LIDAR channels labeled S_{3,1,1-M}. As a result, the outbound LIDAR signal that carries LIDAR channels S_{1,1,1-M} and the outbound LIDAR signal that carries LIDAR channels labeled S_{3,1,1-M} are output from alternate waveguide that have the same alternate waveguide index (i=1) on different cores (k=1 versus k=3). Comparing the directions that the outbound LIDAR signal (system output signal) carrying LIDAR channels S_{1,1,1-M} travels away from the LIDAR system to the direction that the outbound LIDAR signal (system output signal) carrying LIDAR channels S_{3,1,1-M} travel away from the LIDAR system illustrates that the outbound LIDAR signals (system output signals) from different cores travel away from the LIDAR system in different directions. This change in direction occurs when the outbound LIDAR signals carry the same wavelength channel or different wavelength channels and/or are out from alternate waveguides with the same or different waveguide indices. For instance, the direction that the system output signal travels away from the LIDAR system changes in response to changes in the alternate waveguide that receives the active outgoing LIDAR signal. Accordingly, the direction that the system output signal travels away from the LIDAR system is a function of the alternate waveguide that receives the active outgoing LIDAR signal.

The electronics can operate the signal selectors 14 on different cores so as to change the alternate waveguide 16 that receives the outbound LIDAR signal and steer the resulting system output signal from each of the cores within the LIDAR system's field of view. Accordingly, the electronics can operate the signal selectors 14 on different cores so as to steer the system output signals to different sample regions within the core's field of view. As a result, each of the signal selectors 14 can operate as a solid-state beam steerer. A suitable method of operating the signal selectors 14 on different cores and/or the one or more beam steering components 78 so as to steer the system output signals to different sample regions within the LIDAR system's field of view is disclosed in U.S. patent application Ser. No. 17/580,623, filed on Jan. 20, 2022, entitled “Imaging System Having Multiple Cores,” and incorporated herein in its entirety.

The LIDAR chip and/or the optical component assembly 75 can be constructed such that each of the LIDAR channels S_{k,i,m} is incident on the chromatic disperser 77 at a different location and/or at a different angle of incidence. For instance, the LIDAR chip and/or the optical component assembly 75 can be constructed such that an outbound LIDAR signal carrying different LIDAR channels S_{k,i,m} is incident on the chromatic disperser 77 at a different location and/or at a different angle of incidence and outbound LIDAR signals carrying different LIDAR channels S_{k,i,m} are incident on the chromatic disperser 77 at different locations and/or at a different angle of incidences. This difference in incident locations and/or incident angles can provide the difference in directions that the different LIDAR channels S_{k,i,m}, and accordingly the different system output signals, travel away from the LIDAR system.

The LIDAR channels from different alternate waveguides (S_{k,i,1-M}) can be incident on the chromatic disperser 77 at a different location and/or at a different angle of incidence as a result of the facets of alternate waveguides 16 on the same core being spaced apart as shown in FIG. 1A and FIG. 2 and/or as a result of the facets of the alternate waveguides 16 on different cores being spaced apart as shown in FIG. 2. For instance, if the optical component assembly 75 of FIG. 2 excluded the signal director 76 and the alternate waveguides 16 are constructed such that the outbound LIDAR signals exit the different alternate waveguides 16 traveling in parallel or substantially in parallel, each of the outbound LIDAR signals carrying a LIDAR channel from a different one of the alternate waveguides (S_{k,i,1-M}) would be incident on the chromatic disperser 77 at a different location. As is evident from the functionality of dispensers 77 such as prisms, the outbound LIDAR signal(s) being incident on the chromatic disperser 77 at different locations results in system output signals that carry different LIDAR channels traveling away from the LIDAR system in different directions.

The construction of the signal director 76 can be selected such that the LIDAR channels from different alternate waveguides (S_{k,i,1-M}) can be incident on the chromatic disperser 77 at a different location and/or at a different angle of incidence. For instance, the signal director 76 in FIG. 2 is a concave lens. The lens is positioned such that an outbound LIDAR signal transmitted from different alternate waveguides (S_{k,i,1-M}) on the same core is incident on the signal director 76 at different angles of incidence and/or outbound LIDAR signal from different cores are incident on the signal director 76 at different angles of incidence. As a result, an outbound LIDAR signal output from different alternate waveguides (S_{k,i,1-M}) on the same core each travels away from the signal director 76 in a different direction and/or outbound LIDAR signals output from different cores travel away from the signal director 76 in a different direction. outbound LIDAR signal(s) traveling away from the signal director 76 in a different direction are incident on the chromatic disperser 77 at a different location and/or at a different angle of incidence. As is evident from FIG. 2, the different and/or different angle of incidence of the outbound LIDAR signals on the disperser 77 provides system output signals that can travel away from the LIDAR system in different directions. In some instances, the system output signals travel away from the LIDAR system in non-parallel directions.

There are K*N different LIDAR channels that carry the same wavelength. As a result, there can be at least K*N directions that the LIDAR system can output a system output signal. Accordingly, the LIDAR system can provide solid-state steering (steering without moving parts) of system output signals that carry the same wavelength channel in K*N different directions. In some instances, the LIDAR system concurrently outputs K system output signals where one system output signal is output from each of the cores and the system output signals from different cores each carries the same wavelength channel. In these instances, each of the K system output signals can be steered in N different directions.

As shown in FIG. 2, the outbound LIDAR signals that exit from the wavelength chromatic disperser 77 can serve as system output signals for the LIDAR system; however, the optical component assembly 75 can optionally include other optical components. For instance, FIG. 2 illustrates the optical component assembly 75 including one or more beam steering components 78 that receive the outbound LIDAR signals output from the wavelength chromatic disperser 77. The portion of the outbound LIDAR signals output from one or more beam steering components 78 serve as the system output signals for the LIDAR system. The electronics can operate the one or more beam steering components 78 so as to steer each of the system output signal to different sample regions in the field of view. As is evident from the arrows labeled A and B in FIG. 2, the one or more beam steering components 78 can be configured such that the electronics can steer the system output signals in one dimension or in two dimensions. As a result, the one or more beam steering components 78 can function as a beam-steering mechanism that is operated by the electronics so as to steer the system output signals within the field of view of the LIDAR system. Accordingly, the one or more system output signals output by the LIDAR system can be steered within the LIDAR system's field of view by operating the one or more beam steering components 78 in combination with switching the wavelength channel carried by all or a portion of the system output signals and/or switching the selection of alternate waveguides that output the system output signals.

Suitable beam steering components 78 include, but are not limited to, movable mirrors, polygon mirror, MEMS mirrors, optical phased arrays (OPAs), optical gratings, and actuated optical gratings. In some instances, the signal director 76, wavelength chromatic disperser 77, and/or the one or more beam steering components 78 are configured to operate on the outbound LIDAR signals such that the system output signals are collimated or substantially collimated as they travel away from the LIDAR system. Additionally, or alternately, the LIDAR system can include one or more collimating optical components (not illustrated) that operate on the outbound LIDAR signals, and/or the system output signals such that the system output signals are collimated or substantially collimated as they travel away from the LIDAR system.

The system output signals can be reflected by an object located outside of the LIDAR system. All or a portion of the reflected light from a system output signal can return to the LIDAR system as a system return signal. When the LIDAR system includes one or more beam steering components 78, each of the system return signals is received at the one or more beam steering components 78. The one or more beam steering components 78 output at least a portion of each of the system return signals as a returned signal. The returned signals are each received at the chromatic disperser 77. When the LIDAR system excludes one or more beam steering components 78, each of the system return signals can serve as one of the returned signals 77 received at the chromatic disperser 77. The chromatic disperser 77 directs returned signal to the one or more signal directors 76. The one or more signal directors 76 outputs at least a portion of each one of the returned signals as a LIDAR input signal. Each of the different LIDAR input signals is received by one of the alternate waveguides on a different one of the cores 4. Each of the LIDAR input signals includes or consists of light from the outbound LIDAR signal that was output from the core that receives the LIDAR input signal. Additionally, the LIDAR input signal received at an alternate waveguide includes or consists of the light from the outbound LIDAR signal and system output signal that was output from the same alternate waveguide.

The optical component assembly 75 can have configurations other than the configuration shown in FIG. 2. For instance, the one or more beam steering components 78 can be positioned between the signal director 76 and the LIDAR chip. Additionally, the optical component assembly 75 can include optical components that are not illustrated. For instance, the optical component assembly 75 can include one or more lenses configured to increase collimation of the outbound LIDAR signals and/or other signals derived from the outbound LIDAR signals and/or that include light from the outbound LIDAR signals.

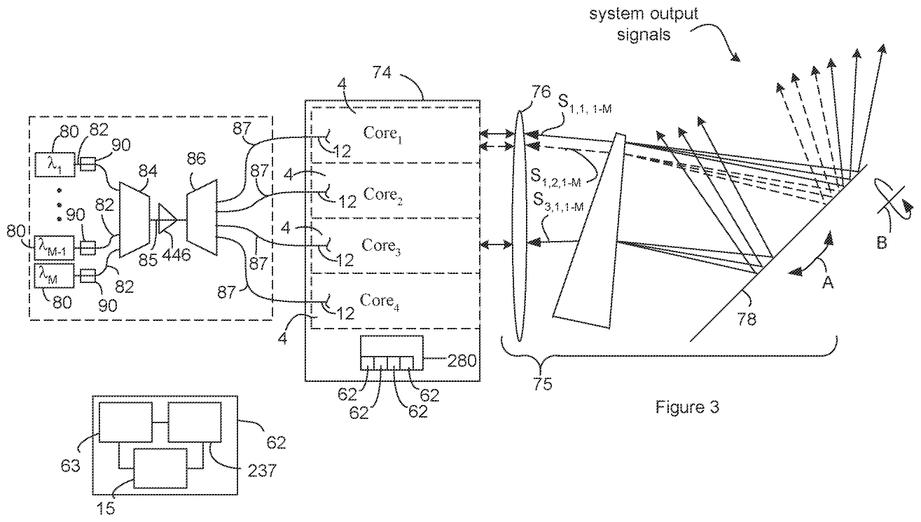

Although the light source 10 is shown as being positioned off the LIDAR chip, all or a portion of the light source 10 can be located on the LIDAR chip. FIG. 3 illustrates an example of a light source 10 used in conjunction with the LIDAR system of FIG. 2. The light source 10 includes multiple laser sources 80. Each of the laser sources 80 is configured to output a wavelength channel signal on a source waveguide 82. Each wavelength channel signal can carry one of the m=1-M wavelength channels. For instance, FIG. 3 illustrates one possible arrangement where the source waveguide 82 that guides the wavelength channel signal carrying wavelength channel m is labeled λₘ where m represents the wavelength channel index and the wavelength channel(s) are each associated with wavelength channel index m=1 through m=M.

Each of the source waveguides 82 carries a wavelength channel signal to a signal mixer 84 that combines the wavelength channel signals so as to form a light signal that is received on a channel waveguide 85. The light signal mixer 84 can be a wavelength dependent multiplexer including, but not limited to, an Arrayed Waveguide Grating (AWG) multiplexer, and an echelle grating multiplexer. The light signal mixer 84 can also be a wavelength independent mixer including, but not limited to, cascaded Y-junctions, cascaded MMI splitters, and a star coupler.

A light signal splitter 86 receives the light signal from the channel waveguide 85. The light signal splitter 86 is configured to divide the light signal among multiple core waveguides 87. The portion of the light signal received by a core waveguide 87 can serve as an outgoing LIDAR signal predecessor. Each of the core waveguides 87 carries one of the outgoing LIDAR signal predecessors to the utility waveguide 12 on a different one of the cores 4. The portion of the outgoing LIDAR signal predecessor received by a utility waveguide 12 serves as the outgoing LIDAR signal precursor received by the utility waveguide 12. The light signal splitter 86 can be a wavelength independent splitter including, but not limited to, a cascaded Y-junction, cascaded MMI splitter, and a star coupler.

An outgoing LIDAR signal precursor, the resulting active outgoing LIDAR signal, the resulting outbound LIDAR signal, and the system output signal each carries light from one of the wavelength channel signals. Since each of the wavelength channel signals carries one of the wavelength channels, the electronics can operate the light source 10 such that the outgoing LIDAR signal precursors received by the utility waveguides 12 of the different cores carries one of the wavelength channels. For instance, the electronics can operate the laser sources 80 independently such that only one of the laser sources 80 outputs a wavelength channel signal while the other laser sources 80 do not output a wavelength channel signal. As an example, the electronics can turn on the laser sources 80 that outputs the desired wavelength channel signal and turn off the source(s) 80 that do not output the desired wavelength channel signal. When the laser sources 80 are each a gain element or laser chip, the light source controller 63 can apply an electrical current through the gain element or laser cavity in one of the laser sources 80 so as to cause that laser source to output a wavelength channel signal while refraining from applying an electrical current through the gain element or laser cavity in the one or more remaining laser source(s) 80 so they do not output a wavelength channel signal. As a result, the outgoing LIDAR signal precursor received by the utility waveguides 12 of different cores carries one of the wavelength channels. The electronics can also operate the laser source(s) 80 so as to change the wavelength channel that is present in the outgoing LIDAR signal precursors received by the cores. For instance, the light source controller 63 can change the laser source to which the electrical current is applied. The light source to which the electrical current is applied can be the light source that outputs the wavelength channel signal that carries the wavelength channel that is currently desired for the outgoing LIDAR signal precursors and accordingly the resulting system output signals.

The light source 10 can optionally include one or more modulators 90 that are each positioned so as to modulate one of the wavelength channel signals. For instance, the light source 10 can optionally include one or more modulators 90 positioned along each of the source waveguides 82. The light source controller 63 can operate each of the modulators 90 so as to allow a wavelength channel signal carried in a source waveguide 82 to pass the modulator 90 without attenuation from the modulator or such that the wavelength channel signal carried in a source waveguide 82 is attenuated by the modulator. The attenuation can be sufficient that the attenuated wavelength channel is not substantially present in the channel waveguide 85. As a result, the attenuation can be sufficient that the attenuated wavelength channel is not substantially present in the outgoing LIDAR signal precursors output from the light source and is accordingly not substantially present in the system output signals output from the LIDAR system. As a result, an alternative to the light source controller 63 turning laser sources 80 on and off so as to select the wavelength channel carried in the system output signals, the light source controller 63 can keep the laser sources that generate the needed channel wavelengths “on” and also operate the one or more modulators 90 so the outgoing LIDAR signal precursors carry the currently desired wavelength channel. Accordingly, the light source controller 63 can keep the laser sources that generate the channel wavelengths that will be needed “on” while operating the one or more modulators 90 so the system output signal(s) carry the currently desired wavelength channel. As an example, when it is desired for the outgoing LIDAR signal precursors and system output signals to carry wavelength channel λ₂, the source controller 63 can operate laser sources 80 that generate channel wavelengths λ₁-λ_{M} such that each of these laser sources 80 concurrently outputs a wavelength channel signal and can operate the modulators 90 such that the wavelength channel signal that carries wavelength channel λ₂ passes the associate modulator 90 but the wavelength channel signals carrying λ₁ and λ₃ through λ_{M} are attenuated such that wavelength channels λ₁ and wavelength channels λ₃ through λ_{M} are not substantially present in the resulting outgoing LIDAR signal precursors and are accordingly not substantially present in the resulting outgoing LIDAR signal precursors and in the resulting system output signals. Suitable modulators 90 include, but are not limited to, Variable Optical Attenuators (VOAs), Mach-Zehnder modulators. An example of a suitable optical attenuator can be found in U.S. patent application Ser. No. 17/396,616, filed on Aug. 6, 2021, entitled “Carrier Injector Having Increased Compatibility,” and incorporated herein in its entirety.

When a light source 10 is constructed as shown in FIG. 3, each of the outgoing LIDAR signal precursors, the resulting active outgoing LIDAR signals and system output signals concurrently carries the same wavelength channel, however, other light source configurations are possible.

Suitable waveguides for use as the source waveguide 82, channel waveguide 85, and/or the core waveguides 87 include, but are not limited to optical fibers and planar optical waveguides. Although FIG. 3 illustrates the light source 10 as separate from the LIDAR chip, all or a portion of the light source 10 can be positioned on the LIDAR chip and/or integrated into the LIDAR chip. As a result, suitable waveguides for use as the source waveguide 82, channel waveguide 85, and/or the core waveguides 87 also include, but are not limited to rib waveguides, ridge waveguides, buried waveguides.

All or a portion of the electronics 62 associated with different cores can optionally be consolidated in the assembly electronics 280 illustrated in FIG. 2. For instance, the light source controller 63 can be included in the assembly electronics 280 rather than in the electronics 62 associated with each of the individual cores. The combination of the electronics 62 for each of the one or more cores and the assembly electronics 280 serve as the electronics for the LIDAR system. The LIDAR system electronics can operate the LIDAR system and generate the LIDAR data for the LIDAR system.

The assembly electronics 280 can be positioned on the LIDAR chip or can be external to the LIDAR chip. The assembly electronics 280 can collect or generate the LIDAR data results from different cores, and/or can coordinate the LIDAR data results from different cores so as to assemble LIDAR data results for the LIDAR system's field of view. For instance, the assembly electronics 280 can stitch together LIDAR data results for the fields of view of different cores so as to form LIDAR data results for the LIDAR system's field of view.

Although FIG. 2 and FIG. 3 illustrate four cores on the LIDAR chip (K=4), the LIDAR chip can include one (K=1), two (K=2), or more than two cores. Suitable numbers of cores on the LIDAR chip and suitable values for K, include, but are not limited to, numbers greater than or equal to 2, 4, or 6 and/or less than 32, 64, or 128.

FIG. 2 illustrates each of the cores associated with the electronics 62 that operate the core and/or generate the LIDAR data for the core. However, the electronics 62 for different cores 62 and the assembly electronics 280 need not be separate and can be incorporated into the same electronics for the system as shown in FIG. 3.

The distance between the facets of alternate waveguides 16 can be selected to achieve a particular pattern for the density of pixels in the field of view of the LIDAR system. For instance, FIG. 4A illustrates a LIDAR system constructed according to FIG. 2. In order to simplify the illustration, the LIDAR system is shown with K=2 cores that each has N=4 alternate waveguides. The facets of the alternate waveguides 16 are arranged in an array. The distance between the facets of two adjacent alternate waveguides 16 is labeled d. The distance d represents a center-to-center distance. The distances between the facets of the alternate waveguides 16 is selected such that the density of the facets is higher in the middle of the facet array than toward the edges of the array.

FIG. 4A also illustrates the system output signals output from the optical component assembly 75 as a result of the illustrated configuration of alternate waveguides 16. The increased density of the facets in the middle of the facet array can increase the density of the system output signals near the middle of the array of system output signals output by the LIDAR system as shown in FIG. 4A. As will be described below, the increased density of the system output signals near the middle of the array of system output signals output by the LIDAR system can produce an increased density of pixels in the center of the field of view.

Each of the system output signals illustrated in FIG. 4A carries the same wavelength channel m=1. However, the light source controller 63 can operate the light source 10 so as to change the wavelength channel carried by the system output signals. For instance, FIG. 4B illustrates the LIDAR system of FIG. 4A after the system output signals have changed from carrying wavelength channel m=1 to wavelength channel m=2. The system output signals shown by dashed lines in FIG. 4B represent system output signals carrying wavelength channel m=2 and the system output signals shown by dashed lines in FIG. 4B represent system output signals carrying wavelength channel m=1 and are arranged as shown in FIG. 4A. As illustrated, the change in wavelength channel causes a shift in the direction that the system output signals travel away from the LIDAR system. In some instances, the

FIG. 4C is a schematic of the relationship between the field of view and the LIDAR system shown in FIG. 4A and FIG. 4B. The field of view is represented by the dashed lines that extend from the LIDAR system to an imaginary surface within the field of view. In order to show the extent of the field of view, the imaginary surface is positioned at a maximum operational distance (labeled d_{M}) from the LIDAR system. The maximum operational distance can generally be considered the maximum distance for which the LIDAR system is configured to provide reliable LIDAR data. In reality, the imaginary surface can have a curved shape due to the fixed nature of the maximum operational distance, however, a planar surface is shown to simplify the following discussion.

While the LIDAR system can concurrently output multiple system output signals, FIG. 4B illustrates the LIDAR system outputting a single system output signal. In FIG. 4B, a portion of a sample region illuminated by the system output signal is illustrated by the polygon on the plane of FIG. 4B. The electronics generate LIDAR data in a series of cycles by sequentially illuminating different sample regions in the field of view for the LIDAR system. LIDAR data can be generated for each of the sample regions. For instance, a sample region is the portion of the field of view that is illuminated during the cycle that is used to generate the LIDAR data for the sample region. As a result, each of the LIDAR data results is associated with one of the cycles and one of the sample regions. The LIDAR data results can stitch together the LIDAR data results from multiple different sample regions to generate LIDAR data results for the field of view.

In FIG. 4C, only a portion of the illustrated sample region is shown as illuminated by the system output signal because the electronics can operate the one or more beam steering mechanisms to steer the system output signal during the data period(s) associated with the sample region. For instance, the one or more beam steering mechanisms can scan the system output signal in the direction of the arrow labeled A for the duration of a cycle. This scan can cause the system output signal to illuminate the length of the polygon labeled ct during the cycle. Although the sample region is shown as two dimensional in FIG. 4C, the sample region is three-dimensional and can extend from the rectangle on the illustrated plane back to the LIDAR system. As a result, each sample region can serve as a three-dimensional pixel within the field of view.

FIG. 4D is a sideview of an example of the imaginary plane from FIG. 4C. The imaginary plane can be a two-dimensional representation of the field of view of the LIDAR system. The left side of field of view contains a column of sample regions illustrated by dashed lines and labeled “solid-state.” The sample regions in the column labeled “solid-state” can result from scanning the field using the signal selector 14 but not using the one or more beam steering mechanisms to steer the system output signals. As a result, the sample regions in the column labeled “solid-state” are a result of solid-state scanning of the system output signals. The sample regions in the column labeled “solid-state” can result from a LIDAR system having K=4 cores that each has N=4 alternate waveguides. When the active outgoing LIDAR signal is received by one of the alternate waveguides, the LIDAR system can concurrently output four different system output signals that are each directed to a different sample region. For instance, when an active outgoing LIDAR signal is received at one of the alternate waveguides, the LIDAR system can concurrently output four different system output signals that are each directed to one of the sample regions illustrated by a combination of solid and dashed lines in the column labeled “Solid-state.” The sample region to which each of the four system output signals is directed can be changed by changing the alternate waveguide that receives the active outgoing LIDAR signal through operation of the signal selector 14. As a result, the LIDAR system can illuminate the sixteen (K*N) different sample regions in the column labeled “solid-state” by operation of the signal selector 14 so as to change the alternate waveguide from which the system output signals originate.

The electronics can also operate the one or more beam steering mechanisms to steer the system output signals to the sample regions illustrated by the solid lines in FIG. 4D. For instance, FIG. 4D also shows an axis labeled x₁ and an axis labeled x₂. The movement of the system output signals in the direction of the axis labeled x₁ can be achieved through the use of the signal selector 14. The movement of the system output signals in the direction of the axis labeled x₂ can be achieved through the use of the one or more beam steering mechanisms. The axis labeled x₂ can also represent time.

The LIDAR system can be constructed such that the field of view has one or more concentrated regions and one or more diluted regions. The concentration of the sample regions in each of the one or more concentrated regions is higher than the concentration of sample regions in each of the one or more diluted regions. The field of view shown in FIG. 4D includes a concentrated region (labeled hd) between diluted regions (labeled 1d). The concentrated region results from the configuration of alternate waveguide disclosed in the context of FIG. 4A. The increased density of the sample regions in the concentrated region can be a result of the increased density of the facets in the middle of the facet array and the resulting increase in the density of the system output signals near the middle of the array of system output signals output by the LIDAR system as shown in FIG. 4A.

The LIDAR system can shift the location of the one or more concentrated regions within the field of view. For instance, in FIG. 4D, the wavelength channel is held constant during the scanning of the sample regions shown in FIG. 4D. As an example, each of the system output signals can carry the wavelength channel with channel index m=1 (λ₁) during the scanning of the sample regions shown in FIG. 4D. FIG. 4E illustrates the result of the LIDAR system scanning the scanning the same field of view while the wavelength channel is held constant at a different wavelength channel. As an example, during the scanning of the sample regions shown in FIG. 4E, each of the system output signals can carry the wavelength channel with channel index m=2 (λ₂). The change in wavelength channel carried by the system output signals can be a result of the light source controller 63 (not shown) operating the light source so as to change the wavelength channel carried by the outgoing LIDAR signal precursor and the resulting active outgoing LIDAR signal from the wavelength channel with channel index m=1 (λ₁) to the wavelength channel with channel index m=2 (λ₂).

A comparison on FIG. 4D and FIG. 4E shows that the sample regions have shifted lower in the field of view as a result of the change in the wavelength channel carried by the system output signals. The shift in the location of the sample regions is also evident from FIG. 4B. In FIG. 4B, the system output signals that carry wavelength channel index m=1 (λ₁) are shown by solid lines while the system output signals that carry wavelength channel index m=2 (λ₂) are shown by dashed lines. The change in wavelength channel carried by each of the system output signal shifts each of the system output signals in the same direction. As a result, the shift in the locations of sample regions also shifts the location where the highest density of sample regions can be found within the field of view. Accordingly, the electronics can tune the location of the one or more concentrated regions within the field of view.

Although FIG. 4A illustrates the density of the facets being higher in the middle of the facet array than toward the edges of the array, the facets of the alternate waveguides 16 can be arranged in other configurations. For instance, the density of the facets can be lower in the middle of the facet array than toward one or more edges of the array. Alternately, the density of the facets can be higher at one or more edges of the array and decrease moving toward the opposing edge of the array.

The closest pair of adjacent alternate waveguide facets 16 or one of the closest pairs of adjacent alternate waveguide facets 16 can serve as reference facets. The distance between the reference facets can serve as a reference distance. The facets can be arranged such that the distance between adjacent facets (d) becomes larger or stays the same for each pair of adjacent pair starting at the reference facets and moving toward one or both ends of the array and the distance between adjacent facets (d) becomes larger for at least a portion of the adjacent pairs starting at the reference facets and moving toward one or both ends of the array. The distance between adjacent facets (d) can increase linearly or non-linearly as a function of distance for each pair of adjacent pair starting at the reference facets and moving toward one or both ends of the array. In some instances, the facets of the alternate waveguides 16 in the array are arranged such that the largest distance between adjacent facets (d) is greater than or equal to 1.5, 2, or 4 and less than 5, 10, or 20 times the reference distance. Additionally, or alternately, the facets of the alternate waveguides 16 can be arranged such that the distance between adjacent facets for all or a portion of the adjacent pairs of facets in the array are greater than 3 μm, 5 μm, or 10 μm, and less than 50 μm, 500 μm, or 1000 μm.

In some instances, the distance between adjacent facets changes such that there are greater than or equal to 3, 4, N/8, N/4, or (N−1)/2 different distances between the adjacent pairs in the array. In some instances, the distance between adjacent facets is selected such that a first portion of the adjacent pairs have a distance between the adjacent pair that is more than 1.5, 2, or 2.5 times the reference distance and less than 3, 4, or 5 times the reference distance and a second portion of the adjacent pairs have a distance between the adjacent pair that is more than 5, 6, or 7 times the reference distance and less than 8, 9, or 10 times the reference distance. In some instances, the distance between adjacent facets is selected such that a first portion of the adjacent pairs have a distance between the adjacent pair that less than or equal to 1.5, 2, or 2.5 times the reference distance, a second portion of the adjacent pairs have a distance that is more than 1.5, 2, or 2.5 times the reference distance and less than 3, 4, or 5 times the reference distance and a third portion of the adjacent pairs have a distance between the adjacent pair that is more than 5, 6, or 7 times the reference distance.

Although FIG. 4D and FIG. 4E illustrate the density of the sample regions being higher in the middle of the field of view than the density of the sample regions along two edges of the field of view, the facets of the alternate waveguides 16 can be arranged to provide the distribution of sample regions with other patterns. For instance, the facets of the alternate waveguides 16 can be arranged so the density of the sample regions is lower in the middle of the field of view than the density of the sample regions along two edges of the field of view. Alternately, the density of the facets can be arranged so the density of the sample regions is higher along one edge of the field of view decreases moving toward the opposing edge of the field.

The separation distance between the sample regions in the column labeled “solid-state” is at least partially a function of the divergence between adjacent system output signals carrying the same wavelength channel. An example of the divergence between adjacent system output signals carrying the same wavelength channel is labeled da in FIG. 4A (signal divergence). The signal divergence can be measured relative to the center ray of the system output signals. The system output signals with the smallest signal divergence can serve as a reference output signals. The signal divergence for reference output signals can serve as a reference divergence. The facets of the alternate waveguides 16 and the optical component assembly 75 can be configured such that the signal divergence becomes larger or stays the same for each pair of adjacent system output signals starting at the reference output signals and moving toward one or both edges of the field of view and the signal divergence becomes larger for at least a portion of the adjacent system output signals starting at the reference output signals and moving toward one or both edges of the field of view. In some instances, the largest signal divergence between adjacent system output signals is greater than or equal to 2, 5, or 10 and less than 20, 50, or 100 times the reference divergence. Additionally, or alternately, the signal divergence between adjacent system output signals for all or a portion of the system output signals carrying the same channel can be greater than 0.01°, 0.1°, or 0.25° and less than 0.5°, 1°, or 2°.

In some instances, there are greater than or equal to 3, 4, N*K/8, N*K/4, or ((N*K)−1)/2 different signal divergences between the adjacent system output signals. In some instances, a first portion of the adjacent system output signals each has a signal divergence that is more than 1.25, 2, or 2.5 times the reference divergence and less than 3, 4, or 5 times the reference divergence and a second portion of the adjacent system output signals each has a signal divergence that is more than 3, 6, or 7 times the reference divergence and/or less than 8, 9, or 10 times the reference divergence.

The degree of shift in the location of the sample regions within the field of view that occurs in response to the change in the wavelength channel carried by the system output signals is at least partially a function of the divergence between system output signals that originate from the same alternate waveguide but carry adjacent wavelength channels. An example of the divergence between system output signals that originate from the same alternate waveguide but carry adjacent wavelength channels is labeled ϕ in FIG. 4B. In some instances, the divergence between system output signals that originate from the same alternate waveguide but carry adjacent wavelength channels is greater than 1°, or 5° and less than 10° or 20°.

The distance between adjacent sample regions that result from solid-state scanning is labeled dₛ in FIG. 4D and is a measure of the distance between the sample regions in the column labeled solid-state at the maximum operational distance. The distance can be measured from the center ray of the system output signal that illuminates each of the sample regions. The closest pair of adjacent sample regions or one of the closest pairs of adjacent sample regions can serve as reference sample regions. The distance between the reference sample regions can serve as a reference sample region distance. The facets and the optical component assembly 75 can be configured such that the distance between adjacent sample regions becomes larger or stays the same for each pair of adjacent sample regions starting at the reference sample regions and moving toward one or both ends of the field of view and the distance between adjacent sample regions (dₛ) becomes larger for at least a portion of the adjacent sample regions starting at the reference sample regions and moving toward one or both ends of the array. In some instances, the largest distance between adjacent sample regions (dₛ) is greater than or equal to 1.1, 2, or 2.5 and less than 3, 4, or 9 times the reference sample region distance. Additionally, or alternately, the sample regions of the alternate waveguides 16 can be arranged such that the distance between adjacent sample regions for all or a portion of the adjacent pairs of sample regions in the array are greater than 1 cm, 50 cm, or 1 m, and less than 2 m, 5 m, or 10 m.

There can be N*K different sample regions that result from solid state scanning of the field of view. In some instances, there are greater than or equal to 3, 4, N*K/8, N*K/4, or ((N*K)−1)/2 different distances between the adjacent sample regions (dₛ). In some instances, a first portion of the adjacent sample regions each has a distance between the adjacent pair that is more than 1.2, 2, or 2.5 times the reference sample region distance and less than 3, 4, or 5 times the reference sample region distance and a second portion of the adjacent pairs each has a distance between the adjacent pair that is more than 3, 6, or 7 times the reference sample region distance and/or less than 8, 9, or 10 times the reference sample region distance.

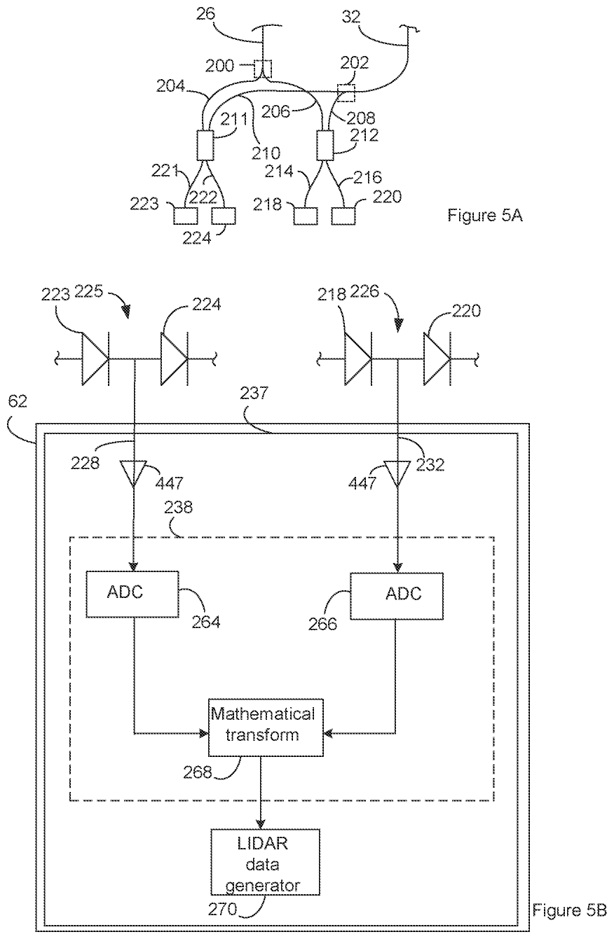

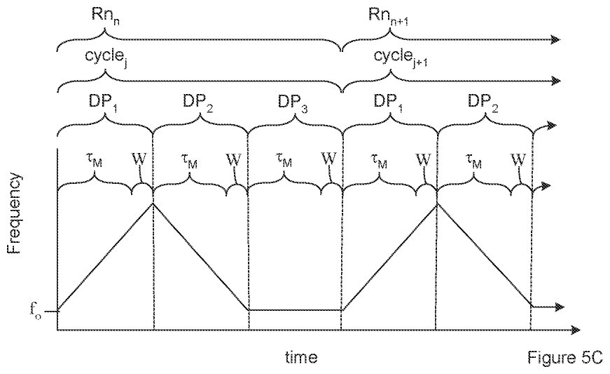

FIG. 5A through FIG. 5B illustrates an example of a light signal processor that is suitable for use as the light signal processor 28 in a LIDAR system constructed according to FIG. 1A. The light signal processor includes an optical-to-electrical assembly configured to convert the light signals to electrical signals. FIG. 5A is a schematic of an example of a suitable optical-to-electrical assembly that includes a first splitter 200 that divides the comparative signal received from the comparative waveguide 26 onto a first comparative waveguide 204 and a second comparative waveguide 206. The first comparative waveguide 204 carries a first portion of the comparative signal to a light combiner 211. The second comparative waveguide 206 carries a second portion of the comparative signal to a second light combiner 212.

The light signal processor of FIG. 5A also includes a second splitter 202 that divides the reference signal received from the reference waveguide 32 onto a first reference waveguide 210 and a second reference waveguide 208. The first reference waveguide 210 carries a first portion of the reference signal to the light combiner 211. The second reference waveguide 208 carries a second portion of the reference signal to the second light combiner 212.

The second light combiner 212 combines the second portion of the comparative signal and the second portion of the reference signal into a second composite signal. Due to the difference in frequencies between the second portion of the comparative signal and the second portion of the reference signal, the second composite signal is beating between the second portion of the comparative signal and the second portion of the reference signal. The first composite signal and the second composite signal are each an example of a composite signal.

The second light combiner 212 also splits the resulting second composite signal onto a first auxiliary detector waveguide 214 and a second auxiliary detector waveguide 216. The first auxiliary detector waveguide 214 carries a first portion of the second composite signal to a first auxiliary light sensor 218 that converts the first portion of the second composite signal to a first auxiliary electrical signal. The second auxiliary detector waveguide 216 carries a second portion of the second composite signal to a second auxiliary light sensor 220 that converts the second portion of the second composite signal to a second auxiliary electrical signal. Examples of suitable light sensors include germanium photodiodes (PDs), and avalanche photodiodes (APDs).

In some instances, the second light combiner 212 splits the second composite signal such that the portion of the comparative signal (i.e. the portion of the second portion of the comparative signal) included in the first portion of the second composite signal is phase shifted by 180° relative to the portion of the comparative signal (i.e. the portion of the second portion of the comparative signal) in the second portion of the second composite signal but the portion of the reference signal (i.e. the portion of the second portion of the reference signal) in the second portion of the second composite signal is not phase shifted relative to the portion of the reference signal (i.e. the portion of the second portion of the reference signal) in the first portion of the second composite signal. Alternately, the second light combiner 212 splits the second composite signal such that the portion of the reference signal (i.e. the portion of the second portion of the reference signal) in the first portion of the second composite signal is phase shifted by 180° relative to the portion of the reference signal (i.e. the portion of the second portion of the reference signal) in the second portion of the second composite signal but the portion of the comparative signal (i.e. the portion of the second portion of the comparative signal) in the first portion of the second composite signal is not phase shifted relative to the portion of the comparative signal (i.e. the portion of the second portion of the comparative signal) in the second portion of the second composite signal. Examples of suitable light sensors include germanium photodiodes (PDs), and avalanche photodiodes (APDs).

The first light combiner 211 combines the first portion of the comparative signal and the first portion of the reference signal into a first composite signal. Due to the difference in frequencies between the first portion of the comparative signal and the first portion of the reference signal, the first composite signal is beating between the first portion of the comparative signal and the first portion of the reference signal.

The light combiner 211 also splits the first composite signal onto a first detector waveguide 221 and a second detector waveguide 222. The first detector waveguide 221 carries a first portion of the first composite signal to a first light sensor 223 that converts the first portion of the second composite signal to a first electrical signal. The second detector waveguide 222 carries a second portion of the second composite signal to a second light sensor 224 that converts the second portion of the second composite signal to a second electrical signal. Examples of suitable light sensors include germanium photodiodes (PDs), and avalanche photodiodes (APDs).

In some instances, the light combiner 211 splits the first composite signal such that the portion of the comparative signal (i.e. the portion of the first portion of the comparative signal) included in the first portion of the composite signal is phase shifted by 180° relative to the portion of the comparative signal (i.e. the portion of the first portion of the comparative signal) in the second portion of the composite signal but the portion of the reference signal (i.e. the portion of the first portion of the reference signal) in the first portion of the composite signal is not phase shifted relative to the portion of the reference signal (i.e. the portion of the first portion of the reference signal) in the second portion of the composite signal. Alternately, the light combiner 211 splits the composite signal such that the portion of the reference signal (i.e. the portion of the first portion of the reference signal) in the first portion of the composite signal is phase shifted by 180° relative to the portion of the reference signal (i.e. the portion of the first portion of the reference signal) in the second portion of the composite signal but the portion of the comparative signal (i.e. the portion of the first portion of the comparative signal) in the first portion of the composite signal is not phase shifted relative to the portion of the comparative signal (i.e. the portion of the first portion of the comparative signal) in the second portion of the composite signal.

When the second light combiner 212 splits the second composite signal such that the portion of the comparative signal in the first portion of the second composite signal is phase shifted by 180° relative to the portion of the comparative signal in the second portion of the second composite signal, the light combiner 211 also splits the composite signal such that the portion of the comparative signal in the first portion of the composite signal is phase shifted by 180° relative to the portion of the comparative signal in the second portion of the composite signal. When the second light combiner 212 splits the second composite signal such that the portion of the reference signal in the first portion of the second composite signal is phase shifted by 180° relative to the portion of the reference signal in the second portion of the second composite signal, the light combiner 211 also splits the composite signal such that the portion of the reference signal in the first portion of the composite signal is phase shifted by 180° relative to the portion of the reference signal in the second portion of the composite signal.

The first reference waveguide 210 and the second reference waveguide 208 are constructed to provide a phase shift between the first portion of the reference signal and the second portion of the reference signal. For instance, the first reference waveguide 210 and the second reference waveguide 208 can be constructed so as to provide a 90-degree phase shift between the first portion of the reference signal and the second portion of the reference signal. As an example, one reference signal portion can be an in-phase component and the other a quadrature component. Accordingly, one of the reference signal portions can be a sinusoidal function and the other reference signal portion can be a cosine function. In one example, the first reference waveguide 210 and the second reference waveguide 208 are constructed such that the first reference signal portion is a cosine function and the second reference signal portion is a sine function. Accordingly, the portion of the reference signal in the second composite signal is phase shifted relative to the portion of the reference signal in the first composite signal, however, the portion of the comparative signal in the first composite signal is not phase shifted relative to the portion of the comparative signal in the second composite signal.

The first light sensor 223 and the second light sensor 224 can be connected as a balanced detector and the first auxiliary light sensor 218 and the second auxiliary light sensor 220 can also be connected as a balanced detector. The balanced detector(s) serve as light sensors that convert a light signal to an electrical signal. FIG. 5B provides a schematic of the relationship between the electronics 62 and one of the light signal processors 28. For instance, FIG. 5B provides a schematic of the relationship between the electronics 62 and the first light sensor 223, the second light sensor 224, the first auxiliary light sensor 218, and the second auxiliary light sensor 220 from the same light signal processor. The symbol for a photodiode is used to represent the first light sensor 223, the second light sensor 224, the first auxiliary light sensor 218, and the second auxiliary light sensor 220 but one or more of these sensors can have other constructions. In some instances, all of the components illustrated in the schematic of FIG. 5B are included on the LIDAR chip. In some instances, the components illustrated in the schematic of FIG. 5B are distributed between the LIDAR chip and electronics located off the LIDAR chip.

The electronics 62 connect the first light sensor 223 and the second light sensor 224 as a first balanced detector 225 and the first auxiliary light sensor 218 and the second auxiliary light sensor 220 as a second balanced detector 226. In particular, the first light sensor 223 and the second light sensor 224 are connected in series. Additionally, the first auxiliary light sensor 218 and the second auxiliary light sensor 220 are connected in series. The serial connection in the first balanced detector is in communication with a first data line 228 that carries the output from the first balanced detector as a first data signal. The serial connection in the second balanced detector is in communication with a second data line 232 that carries the output from the second balanced detector as a second data signal. The first data line and the second data line are each an example of a data line. The first data signal is an electrical data signal that carries a representation of the first composite signal and the second data signal is an electrical data signal that carries a representation of the second composite signal. Accordingly, the first data signal includes a contribution from a first waveform and a second waveform and the second data signal is a composite of the first waveform and the second waveform. The portion of the first waveform in the first data signal is phase-shifted relative to the portion of the first waveform in the first data signal but the portion of the second waveform in the first data signal being in-phase relative to the portion of the second waveform in the first data signal. For instance, the second data signal includes a portion of the reference signal that is phase shifted relative to a different portion of the reference signal that is included the first data signal. Additionally, the second data signal includes a portion of the comparative signal that is in-phase with a different portion of the comparative signal that is included in the first data signal. The first data signal and the second data signal are beating as a result of the beating between the comparative signal and the reference signal, i.e., the beating in the first composite signal and in the second composite signal.

The electronics 62 include a data processor 237 configured to generate the LIDAR data. For the purposes of illustration, FIG. 5B illustrates one data processor in the electronics 62, however, the electronics 62 for a core can include a data processor 237 for each light signal processor 28 operated by the electronics 62.

The data processor 237 includes a beat frequency identifier 238 configured to identify the beat frequency of the composite signal from the first data signal and the second data signal. The beat frequency identifier 238 receives the first data signal and the second data signal. Since the first data signal is an in-phase component and the second data signal its quadrature component, the first data signal and the second data signal together act as a complex data signal where the first data signal is the real component and the second data signal is the imaginary component of the complex data signal.

The data processor 237 includes a first Analog-to-Digital Converter (ADC) 264 that receives the first data signal from the first data line 228. The first Analog-to-Digital Converter (ADC) 264 converts the first data signal from an analog form to a digital form and outputs a first digital data signal. The beat frequency identifier 238 includes a second Analog-to-Digital Converter (ADC) 266 that receives the second data signal from the second data line 232. The second Analog-to-Digital Converter (ADC) 266 converts the second data signal from an analog form to a digital form and outputs a second digital data signal. The first digital data signal is a digital representation of the first data signal and the second digital data signal is a digital representation of the second data signal. Accordingly, the first digital data signal and the second digital data signal act together as a complex signal where the first digital data signal acts as the real component of the complex signal and the second digital data signal acts as the imaginary component of the complex data signal.

The beat frequency identifier 238 includes a mathematical transformer 268 that receives the complex data signal. For instance, the mathematical transformer 268 receives the first digital data signal from the first Analog-to-Digital Converter (ADC) 264 as an input and also receives the second digital data signal from the first Analog-to-Digital Converter (ADC) 266 as an input. The mathematical transformer 268 can be configured to perform a mathematical transform on the complex signal so as to convert from the time domain to the frequency domain. The mathematical transform can be a complex transform such as a complex Fast Fourier Transform (FFT). A complex transform such as a complex Fast Fourier Transform (FFT) provides an unambiguous solution for the shift in frequency of a comparative signal relative to the system output signal.

The mathematical transformer 268 can include a peak finder (not shown) configured to identify peaks in the output of the mathematical transformer 268. The peak finder can be configured to identify any frequency peaks associated with reflection of the system output signal by one or more objects located outside of the LIDAR system. For instance, frequency peaks associated with reflection of the system output signal by one or more objects located outside of the LIDAR system can fall within a frequency range. The peak finder can identify the frequency peak within the range of frequencies associated with the reflection of the system output signal by one or more objects located outside of the LIDAR system. The frequency of the identified frequency peak represents the beat frequency of the composite signal.

The data processor 237 includes a LIDAR data generator 270 that receives the beat frequency of the composite signal from the peak finder. The LIDAR data generator 270 processes the beat frequency of the composite signal so as to generate the LIDAR data (distance and/or radial velocity between the reflecting object and the LIDAR chip or LIDAR system). The transform component 268 can execute the attributed functions using firmware, hardware or software or a combination thereof.

The light source controller 63 operates the light source 10 such that the outbound LIDAR signal and the resulting system output signal have a frequency versus time pattern. For instance, when a light source is constructed according to FIG. 3 and the laser sources include a gain element or laser chip, the light source controller 63 can change the frequency of the outgoing LIDAR signal precursor and the resulting active outgoing LIDAR signal by changing the level of electrical current applied through the gain element or laser cavity. Additionally, or alternately, the light source 10 can include one or more modulators (not shown) that the light source controller 63 can use to modulate the frequency of the outgoing LIDAR signal precursor and the resulting active outgoing LIDAR signal. When the light source 10 includes a modulator one or more, the light source controller 63 can operate the modulator so as to achieve the desired frequency versus time pattern in light signals that include light from the outgoing LIDAR signal precursor and the resulting active outgoing LIDAR signal. The light source controller 63 can execute the attributed functions using firmware, hardware or software or a combination thereof.

FIG. 5C shows an example of a chirp pattern for the outgoing LIDAR signal precursors the resulting active outgoing LIDAR signals, outbound LIDAR signals and the resulting system output signals. FIG. 5C shows an example of a relationship between the frequency of the system output signals, time, cycles, periods and sample regions. The base frequency of the system output signal (fₒ) can be the frequency of the system output signal at the start of a cycle. The frequency versus time pattern shown in FIG. 5C can represent the frequency versus time pattern for the system output signals that are concurrently output from the LIDAR system carrying the same wavelength channel. However, different system output signals that carry the same wavelength channel illuminate a different selection of sample regions. Since FIG. 5C applies to a set of sample regions labeled Rnₙ and Rnₙ+1, the disclosure of FIG. 5C applies to the system output signal that illuminates these sample regions. Additionally, the frequency versus time pattern shown in FIG. 5C is for system output signals carrying a particular one of the wavelength channels. When the wavelength channel is switched, the system output signals can have the same pattern but at the wavelength of the new wavelength channel. Accordingly, the frequency versus time pattern shown in FIG. 5C will be shifted upward or downward in response to the change in wavelength channel.

FIG. 5C shows frequency versus time for a sequence of two cycles labeled cycleⱼ and cycleⱼ₊₁. In some instances, the frequency versus time pattern is repeated in each cycle as shown in FIG. 5C. The illustrated cycles do not include re-location periods and/or re-location periods are not located between cycles. As a result, FIG. 5C illustrates the results for a continuous scan where the steering of the system output signal is continuous.

Each cycle includes multiple data periods labeled DP₁, DP₂, and DP₃. In some instances, the frequency versus time pattern is the same for the data periods that correspond to each other in different cycles as is shown in FIG. 5C. Corresponding data periods are data periods with the same period index. As a result, each data period DP₁ can be considered corresponding data periods and the associated frequency versus time patterns are the same in FIG. 5C. At the end of a cycle, the electronics return the frequency to the same frequency level at which it started the previous cycle.

During the data periods DP₁ the electronics operate the light source such that the frequency of the system output signal changes at a linear rate «. During the data periods DP₂ the electronics operate the light source such that the frequency of the system output signal changes at a linear rate −α.

FIG. 5C labels sample regions that are each associated with a sample region index n and are labeled Rnₙ. FIG. 5C labels sample regions Rnₖ and Rnₖ₊₁. Each sample region is illuminated with the system output signal during the data periods that FIG. 5C shows as associated with the sample region. For instance, sample region Rnₙ is illuminated with the system output signal during the data periods labeled DP₁ through DP₃. The sample region indices n can be assigned relative to time. For instance, the sample regions can be illuminated by the system output signal in the sequence indicated by the index n. As a result, the sample region Rn₁₀ can be illuminated after sample region Rn₉ and before Rn₁₁.

The LIDAR system is typically configured to provide reliable LIDAR data when the object is within an operational distance range from the LIDAR system. The operational distance range can extend from a minimum operational distance to a maximum operational distance. A maximum roundtrip time can be the time required for a system output signal to exit the LIDAR system, travel the maximum operational distance to the object, and to return to the LIDAR system and is labeled τ_{M} in FIG. 5C.

Since there is a delay between the system output signal being transmitted and returning to the LIDAR system, the composite signals do not include a contribution from the LIDAR signal until after the system return signal has returned to the LIDAR system. Since the composite signal needs the contribution from the system return signal for there to be a LIDAR beat frequency, the electronics measure the LIDAR beat frequency that results from system return signal that return to the LIDAR system during a data window in the data period. The data window is labeled “W” in FIG. 5C. The contribution from the LIDAR signal to the composite signals will be present at times larger than the maximum operational time delay (τ_{M}). As a result, the data window is shown extending from the maximum operational time delay (τ_{M}) to the end of the data period.

A frequency peak in the output from a mathematical transform such as a Complex Fourier transform represents the beat frequency of the composite signals that each includes a comparative signal beating against a reference signal. The beat frequencies from two or more different data periods can be combined to generate the LIDAR data. For instance, the beat frequency determined from DP₁ in FIG. 5C can be combined with the beat frequency determined from DP₂ in FIG. 5C to determine the LIDAR data. As an example, the following equation applies during a data period where electronics increase the frequency of the outgoing LIDAR signal precursor and the resulting active outgoing LIDAR signal such as occurs in data period DP₁ of FIG. 5C: f_{ub}=−f_{d}+ατ where f_{ub} is the frequency provided by the transform component, f_{d} represents the Doppler shift (f_{d}=2νf_{c}/c) where fc represents the optical frequency (fₒ), c represents the speed of light, ν is the radial velocity between the reflecting object and the LIDAR system where the direction from the reflecting object toward the chip is assumed to be the positive direction, τ is the time in which the light from the system output signal travels to the object and returns to the LIDAR system (the roundtrip time), and c is the speed of light. The following equation applies during a data period where electronics decrease the frequency of the active outgoing LIDAR signal precursor and the resulting active outgoing LIDAR signal such as occurs in data period DP₂ of FIG. 5C: f_{db}=−f_{d}−α τ where f_{db} is a frequency provided by the transform component (f_{i, LDP} determined from DP₂ in this case). In these two equations, f_{d} and τ are unknowns. These two equations can be solved for the two unknowns. The radial velocity for the sample region then be calculated from the Doppler shift (ν=c*f_{d}/(2f_{c})) and/or the separation distance for that sample region can be calculated from c*τ/2. As a result, the electronics use each of the beat frequencies as a variable in one or more equations that yield the LIDAR data. As an example, the distance between the LIDAR system and an object in the sample region (R) can be determiner from Equation 1: R=c(f_{ub}−f_{db})/(2(α_{ub}−α_{db})) where α_{ub} represents the rate of the frequency increase during the data period. Additionally, f_{db} represents the beat frequency during a data period where source controller 63 decreases the frequency of the outgoing LIDAR signal precursor and the resulting active outgoing LIDAR signal such as occurs in data period DP₂ from FIG. 5C through FIG. 5E and α_{db} represents the rate of the frequency decrease during the data period with a decreasing frequency and α_{ub} represents the rate of the frequency decrease during the data period with an increasing frequency. Additionally, the radial velocity between the reflecting object and the LIDAR system (ν) can be calculated Equation 2: ν=λ(α_{db}f_{ub}−α_{ub}f_{db})/(2(α_{ub}−α_{db})). The LIDAR data generator 270 can execute the attributed functions using firmware, hardware or software or a combination thereof.

The data period labeled DP₃ in FIG. 5C is optional. In some situations, there can be more than one object in a sample region. For instance, during the feedback period in DP₁ for cycle and also during the feedback period in DP₂ for cycle₂, more than one frequency pair can be matched. In these circumstances, it may not be clear which frequency peaks from DP₂ corresponds to which frequency peaks from DP₁. As a result, it may be unclear which frequencies need to be used together to generate the LIDAR data for an object in the sample region. As a result, there can be a need to identify corresponding frequencies. The identification of corresponding frequencies can be performed such that the corresponding frequencies are frequencies from the same reflecting object within a sample region. The data period labeled DP₃ can be used to find the corresponding frequencies. LIDAR data can be generated for each pair of corresponding frequencies and is considered and/or processed as the LIDAR data for the different reflecting objects in the sample region.

An example of the identification of corresponding frequencies uses a LIDAR system where the cycles include three data periods (DP₁, DP₂, and DP₃) as shown in FIG. 5C. When there are two objects in a sample region illuminated by the LIDAR outputs signal, the transform component outputs two different frequencies for f_{ub}: fᵤ₁ and fᵤ₂ during DP₁ and another two different frequencies for f_{db}: f_{d1} and f_{d2} during DP₂. In this instance, the possible frequency pairings are: (f_{d1}, fᵤ₁); (f_{d1}, fᵤ₂); (f_{d2}, fᵤ₁); and (f_{d2}, f_{du2}). A value of fa and t can be calculated for each of the possible frequency pairings. Each pair of values for fa and t can be substituted into f₃=−f_{d}+α₃τ₀ to generate a theoretical f₃ for each of the possible frequency pairings. The value of α₃ is different from the value of a used in DP₁ and DP₂. In FIG. 5C, the value of α₃ is zero. In this case, the transform component also outputs two values for f₃ that are each associated with one of the objects in the sample region. The frequency pair with a theoretical f₃ value closest to each of the actual f₃ values is considered a corresponding pair. LIDAR data can be generated for each of the corresponding pairs as described above and is considered and/or processed as the LIDAR data for a different one of the reflecting objects in the sample region. Each set of corresponding frequencies can be used in the above equations to generate LIDAR data. The generated LIDAR data will be for one of the objects in the sample region. As a result, multiple different LIDAR data values can be generated for a sample region where each of the different LIDAR data values corresponds to a different one of the objects in the sample region.

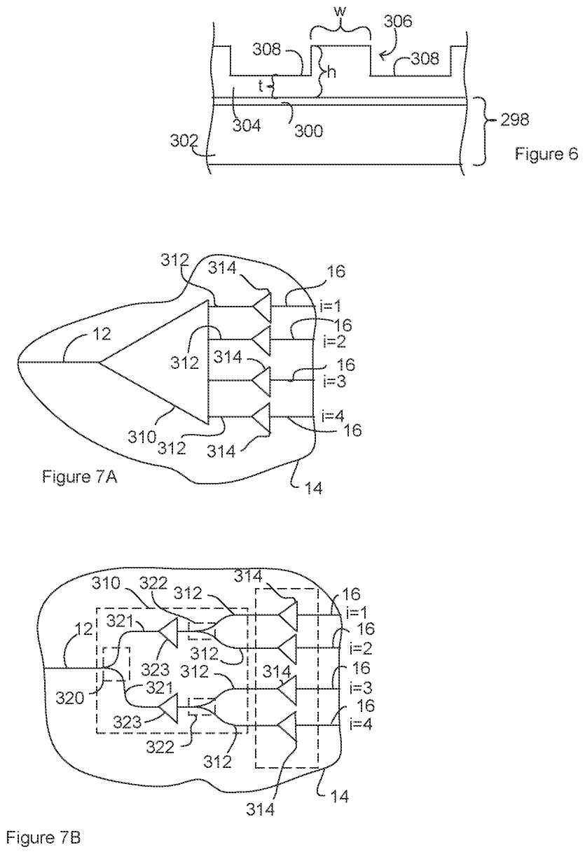

The portion of the LIDAR chip illustrated in FIG. 6 includes a waveguide construction that is suitable for use with chips constructed from silicon-on-insulator wafers. A ridge 306 of the light-transmitting medium 304 extends away from slab regions 308 of the light-transmitting medium 304. The light signals are constrained between the top of the ridge and the buried layer 300. As a result, the ridge 306 at least partially defines the waveguide.

The dimensions of the ridge waveguide are labeled in FIG. 6. For instance, the ridge has a width labeled w and a height labeled h. The thickness of the slab regions is labeled t. For LIDAR applications, these dimensions can be more important than other applications because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5 μm and less than 3 μm. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide. Additionally, or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. The waveguide construction of FIG. 6 is suitable for all or a portion of the waveguides on a LIDAR chip constructed according to FIG. 1A.

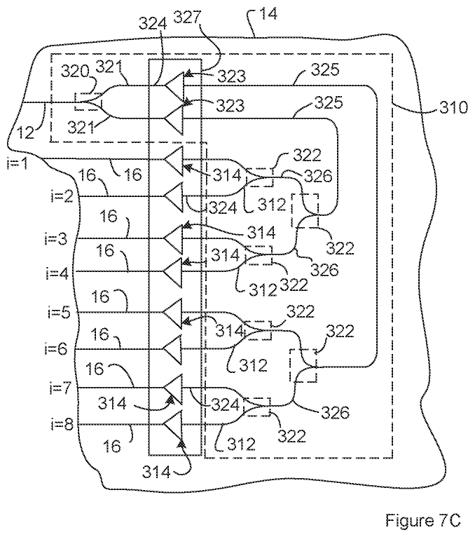

The signal selector 14 can include one or more splitters and one or more amplifiers. FIG. 7A is schematic of an example of a suitable signal selector 14. The signal selector 14 includes a light signal splitter 310 that receives the outgoing LIDAR signal precursor from the utility waveguide 12. The light signal splitter 310 divides the outgoing LIDAR signal precursor into multiple preliminary outgoing LIDAR signals. Each of the preliminary outgoing LIDAR signals is received on a different one of the preliminary alternate waveguides 312. The light signal splitter 310 can be a wavelength independent splitter. Suitable wavelength independent splitters include, but are not limited to, cascaded Y-junctions, cascaded MMI splitters, and star couplers. Each of the preliminary alternate waveguides 312 carries one of the preliminary outgoing LIDAR signals to an amplifier 314. Each of the amplifiers 314 is configured to output an outgoing LIDAR signal that includes light from one of the preliminary outgoing LIDAR signals.

The selector controller 15 can operate each of the amplifiers 314 so as to amplify the power of the preliminary outgoing LIDAR signals passing through the amplifier or to allow the preliminary outgoing LIDAR signal to pass through the amplifier without amplification. In some instances, operating an amplifier below an amplification threshold effectively causes attenuation of the preliminary outgoing LIDAR signal. As an example, Semiconductor Optical Amplifiers (SOAs) amplify a preliminary outgoing LIDAR signal when a forward bias is applied to the Semiconductor Optical Amplifier (SOA). When a reverse-bias is applied to the Semiconductor Optical Amplifiers (SOAs), the gain medium absorbs a preliminary outgoing LIDAR signal and further attenuates the preliminary outgoing LIDAR signal through which it travels. Accordingly, when the selector controller 15 operates one of the amplifiers 314 such that the electrical current through the gain medium falls below the current threshold, the amplifier 314 can attenuate the power of the preliminary outgoing LIDAR signal. As a result, the selector controller 15 can operate each of the amplifiers 314 such that the amplifier outputs an outgoing LIDAR signal that is amplified relative to the preliminary outgoing LIDAR signal received by the amplifier 314, that is unamplified relative to the preliminary outgoing LIDAR signal received by the amplifier 314, that is attenuated relative to the preliminary outgoing LIDAR signal received by the amplifier 314, or that has zero, insubstantial or negligible power.

The light signal splitter 310 can include one or more amplifiers. As an example, FIG. 7B is a schematic of a signal selector 14 having a light signal splitter 310 that includes multiple amplifiers 323. The signal splitter 310 includes cascaded splitters. In FIG. 7B, the cascaded splitters are cascaded Y-junctions. A first one of the splitters 320 receives the outgoing LIDAR signal precursor and divides it into outgoing LIDAR signal portions that are each received on a different intermediate waveguide 321. Each of the intermediate waveguides 321 carries one of the outgoing LIDAR signal portions to a cascade splitter 322. Each of the cascade splitters 322 divides the outgoing LIDAR signal portions into multiple preliminary outgoing LIDAR signals that are each received on a different one of the preliminary alternate waveguides 312. The light signal splitter 310 can be a wavelength independent splitter. Suitable wavelength independent splitters include, but are not limited to, cascaded Y-junctions, cascaded MMI splitters, and star couplers.

An amplifier 323 is positioned along each of the intermediate waveguides 321. The selector controller 15 can operate the amplifiers 323 so as to amplify the outgoing LIDAR signal portions and accordingly any resulting outgoing LIDAR signals.

All or a portion of the amplifiers included in the signal selector 14 can be included in an amplifier chip. For instance, an amplifier chip can include all or a portion of the amplifiers 314 and/or all or a portion of the amplifiers 323. As an example, FIG. 7C is a schematic of a signal selector 14 with a light signal splitter 310 that includes amplifiers 323 on an amplifier chip that also includes amplifiers 314. The signal splitter includes cascaded splitters. In FIG. 7C, the cascaded splitters are cascaded Y-junctions. A first one of the splitters 320 receives the outgoing LIDAR signal precursor and divides it into outgoing LIDAR signal portions that are each received on a different intermediate waveguide 321. Each of the intermediate waveguides 321 carries one of the outgoing LIDAR signal portions to an amplifier 323 on an amplifier chip 327. Each of the amplifiers 323 includes an amplifier waveguide 324 that receives the outgoing LIDAR signal portion and outputs a secondary outgoing LIDAR signal portion. Each of the secondary outgoing LIDAR signal portions are received on a secondary intermediate waveguide 325. Each of the secondary intermediate waveguide 325 carries one of the secondary outgoing LIDAR signal portions to a cascade splitter 322. Each of the cascade splitters 322 divides one of the secondary outgoing LIDAR signal portions into multiple preliminary outgoing LIDAR signals that are each received on a different tertiary intermediate waveguide 326. Each of the tertiary intermediate waveguides 326 carries one of the preliminary outgoing LIDAR signals to a cascade splitter 322 that divides one of the preliminary outgoing LIDAR signals into preliminary outgoing LIDAR signals. The preliminary outgoing LIDAR signals are each received on one of the preliminary alternate waveguides 312. Each of the preliminary alternate waveguides 312 carries one of the preliminary outgoing LIDAR signals to an amplifier 314 on the amplifier chip 327. Each of the amplifiers 314 includes an amplifier waveguide 324 that receives one of the preliminary outgoing LIDAR signals. The amplified or unamplified preliminary outgoing LIDAR signal output by each of the amplifiers 314 serves as one of the outgoing LIDAR signals. Each of the outgoing LIDAR signals is received by one of the alternate waveguides 16. Suitable amplifiers 314 and/or amplifiers 323 include, but are not limited to, Semiconductor Optical Amplifiers (SOAs). Suitable splitters 320 and/or cascade splitters 322 include wavelength independent splitters such as Y-junctions, MMI splitters, star couplers, cascaded Y-junctions, and cascaded MMI splitters.

The selector controller 15 can operate the amplifiers 314 so as to select which amplifiers 314 serve as an active amplifier and which amplifiers 314 serve as an inactive amplifier. For instance, the selector controller 15 can operate one or more amplifiers 314 so as to substantially amplify the power of the light included in the system output signal that is output from each of the one or more amplifiers. Additionally, the selector controller 15 can concurrently operate one or more amplifiers 314 so to not amplify, or not substantially amplify, the power of the light included in the system output signal that is output from each of the one or more amplifiers. Any amplifiers that substantially amplify the power of the light included in the system output signal output from the amplifier serve as the active amplifiers. The amplifiers that do not amplify, or do not substantially amplify, the power of the light included in the system output signal serve as the inactive amplifiers. For instance, one example of a suitable amplifier includes Semiconductor Optical Amplifiers (SOAs). Semiconductor Optical Amplifiers (SOAs) include a semiconductor gain medium to which a forward electrical bias so as to amplify the power of the light in the system output signal. These amplifiers can be operated as active amplifiers by applying an electrical bias above a threshold voltage in the direction needed to provide amplification. Semiconductor Optical Amplifiers (SOAs) can also be operated as inactive amplifiers by not applying an electrical bias to the amplifier, by applying the electrical bias below the threshold voltage in the direction needed to provide amplification, by applying a reverse electrical bias to the amplifier so as to attenuate the power of the light in the system output signal, or by applying the electrical bias in the direction opposite from the direction needed to provide amplification. Application of the electrical bias in the direction opposite from the direction needed to provide amplification can provide attenuation of the system output signal. For instance, a forward bias above a voltage threshold is often applied to Semiconductor Optical Amplifiers (SOAs) in order to achieve amplification while application of a reverse bias can provide attenuation. Accordingly, the inactive amplifiers can output a system output signal with a power level that is the same as, substantially the same as, or below the power of the preliminary outgoing LIDAR signal received by the amplifier.

The operation of the amplifiers 314 selects which of the alternate waveguides serves as the active alternate waveguide that receives the active outgoing LIDAR signal. For instance, the outgoing LIDAR signal output from the active amplifier can serve as the active outgoing LIDAR signal and the alternate waveguide the receives the active outgoing LIDAR signal can serve as the active alternate waveguide. In some instances, all or a portion of the amplifiers 314 can have a length such that when the selector controller 15 operates an amplifier as an inactive amplifier, the outgoing LIDAR signal output from the amplifier has zero, or substantially zero, power. As a result, when the selector controller 15 operates all or a portion of the amplifiers as inactive amplifiers, each of the inactive amplifiers effectively do not output a signal. Accordingly, a portion of the inactive alternate waveguides 16 may not receive an inactive outgoing LIDAR signal. However, all or a portion of the amplifiers operated as inactive amplifiers can output a signal with a power level that is negligible or insubstantial relative to the power of the active outgoing LIDAR signal. In the event that one or more of the inactive amplifiers outputs a signal received by an inactive alternate waveguide with a power level that is negligible or insubstantial relative to the power of the active outgoing LIDAR signal, the signal output from the inactive amplifier can serve as an inactive outgoing LIDAR signal. Accordingly, inactive amplifiers can output an inactive outgoing LIDAR signal or no outgoing LIDAR signal at all. While the electronics use light from any active outgoing LIDAR signals to generate LIDAR data, the electronics do not use light from inactive outgoing LIDAR signal to generate LIDAR data. For instance, the electronics can operate the signal processor 28 that is associated with the active outgoing LIDAR signal so as to generate LIDAR data while not generating LIDAR data at the signal processor(s) 28 associated with inactive outgoing LIDAR signals. For instance, the electronics can operate the signal processor 28 that is receiving the comparative signal from the active alternate waveguide so as to generate LIDAR data while not generating LIDAR data at the signal processor 28 that would receive a comparative signal from an inactive alternate waveguide. The act of not generating LIDAR data at a signal processor 28 may be a result of a beating signal not having enough power, a result of the associated inactive outgoing signal not having sufficient power and/or a result of functionality in the electronics.

An alternative to having a data processor 237 for each light signal processor 28 operated by the electronics 62 in a core is to add together the first data signals carried on the first data lines of a core and add together the second data signals carried on the second data lines of the core. The added first data signals and the added second data signals could then be received at the beat frequency identifier 238 and the LIDAR data generator 270 for the generation of the LIDAR data. For instance, the added first data signal can serve as the first data signal input to the LIDAR data generator 270 and the added second data signal can serve as the second data signal input to the LIDAR data generator 270. In this configuration, any beating signals that result from a comparative signal carrying light output from an inactive alternate waveguide does not provide a substantial contribution to the added first data signals or the added second data signals. As a result, the comparative signal carrying light output from the active alternate waveguide is the source of the beat frequency identified by the beat frequency identifier 238 while the comparative signals carrying light output from the inactive alternate waveguide do not contribute to the beat frequency identified by the beat frequency identifier 238. Accordingly, the LIDAR system calculates the LIDAR data from the light output from the active outgoing LIDAR signal but not from the light output from the inactive amplifiers.

In some instances, the selector controller 15 operate the amplifiers 314 such that a ratio of the power of the active outgoing LIDAR signal received by the active alternate waveguide: the power of any inactive outgoing LIDAR signal received by an inactive alternate waveguides is greater than 10,000:1, 1000:1 or 100:1 for each of the inactive alternate waveguides and can be infinitely high when an inactive amplifier 314 outputs an outgoing LIDAR signal with a zero power level or does not output an outgoing LIDAR signal. Additionally or alternately, the selector controller 15 can operate all or a portion of the inactive amplifiers 314 such that a power level of the preliminary outgoing LIDAR signal received by the inactive amplifier is more than 10, 100, or 1000 times a power level of the inactive outgoing LIDAR signal output from the inactive amplifier.

As shown in FIG. 1A, variable optical attenuators 328 can optionally be positioned along the alternate waveguides. Each of the variable optical attenuators 328 can be configured to attenuate the power of an outgoing LIDAR signal carried in one of the alternate waveguides. The electronics can operate the variable optical attenuators 328. For instance, the selector controller 15 can operate each of the variable optical attenuators so as to attenuate the power of the outgoing LIDAR signal carried in one of the alternate waveguides. Each variable optical attenuator that receives an inactive outgoing LIDAR signal can serve as inactive optical attenuators and each variable optical attenuator that receives an active outgoing LIDAR signal can serve as an active optical attenuator. The selector controller 15 can operate the inactive variable optical attenuators so as to attenuate the power of any inactive outgoing LIDAR signal without attenuating while operating any active variable optical attenuators so as to not attenuate, or not substantially attenuate, any active outgoing LIDAR signals. In some instances, operating an active variable optical attenuator so as to not attenuate, or not substantially attenuate, an active outgoing LIDAR signals includes refraining from an activity that causes the variable optical attenuator to provide attenuating functionality. For instance, in some instances, operating an active variable optical attenuator so as to not substantially attenuate an active outgoing LIDAR signals includes refraining from applying an electrical bias to the active variable optical attenuator. In response to changes in the alternate waveguide that serves as the active alternate waveguide, the selector controller 15 can change the selectin of variable optical attenuators that are inactive variable optical attenuators and active variable optical attenuators.

In some instances, the operation of one or more of the amplifiers may not reduce the power of the inactive outgoing LIDAR signal output from the amplifier to the desired power level. The selector controller 15 can operate the variable optical attenuators so as to reduce the power of each inactive outgoing LIDAR signal to the desired level. In some instances, the selector controller 15 operates all or a portion of the inactive amplifiers 314 and the associated variable optical attenuators such that a power level of the preliminary outgoing LIDAR signal received by each inactive amplifier is more than 100, 1000, or 10,000 times a power level of the inactive outgoing LIDAR signal output from the variable optical attenuator that receives the inactive outgoing LIDAR signal output from the amplifier. Additionally or alternately, the selector controller 15 can operate the amplifiers 314 and variable optical attenuators such that a ratio of the power of the active outgoing LIDAR signal output from each active variable attenuator: the power of any inactive outgoing LIDAR signal output from each inactive variable attenuator is greater than 10,000:1, 1000:1 or 100:1.

As noted above, the selector controller 15 can operate the variable optical attenuators such that the active outgoing LIDAR signal carried in one or more of the alternate waveguides is not attenuated or is not substantially attenuated. Variable optical attenuators such as PIN diode based VOAs provide attenuation by apply a bias to the attenuator above a voltage threshold. By applying a bias below the voltage threshold to the attenuator positioned along the alternate waveguide carrying the active outgoing LIDAR signal, the active outgoing LIDAR signal is not attenuated or is not substantially attenuated. Suitable variable optical attenuators include, but are not limited to, PIN diode based VOAs, liquid crystal variable attenuators, and Lithium Niobate devices.

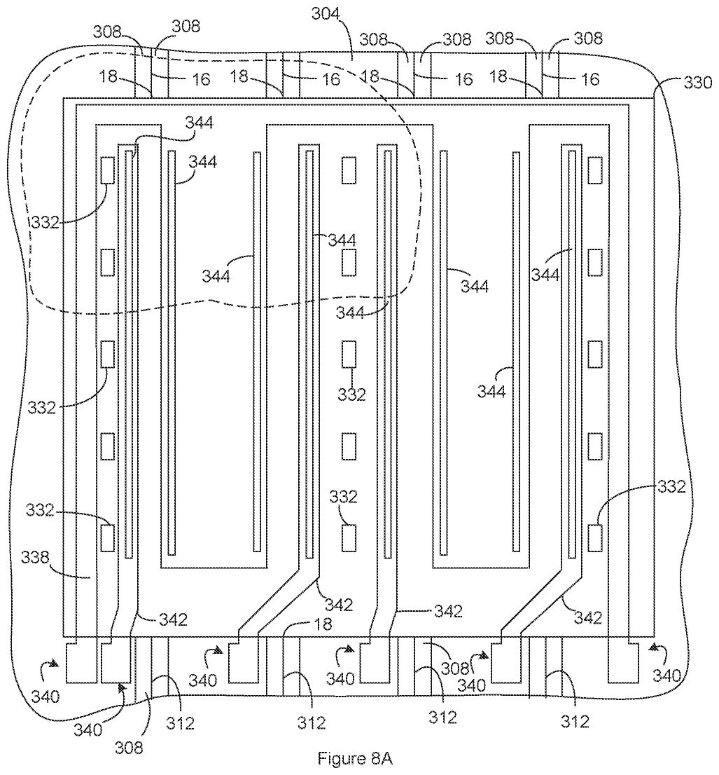

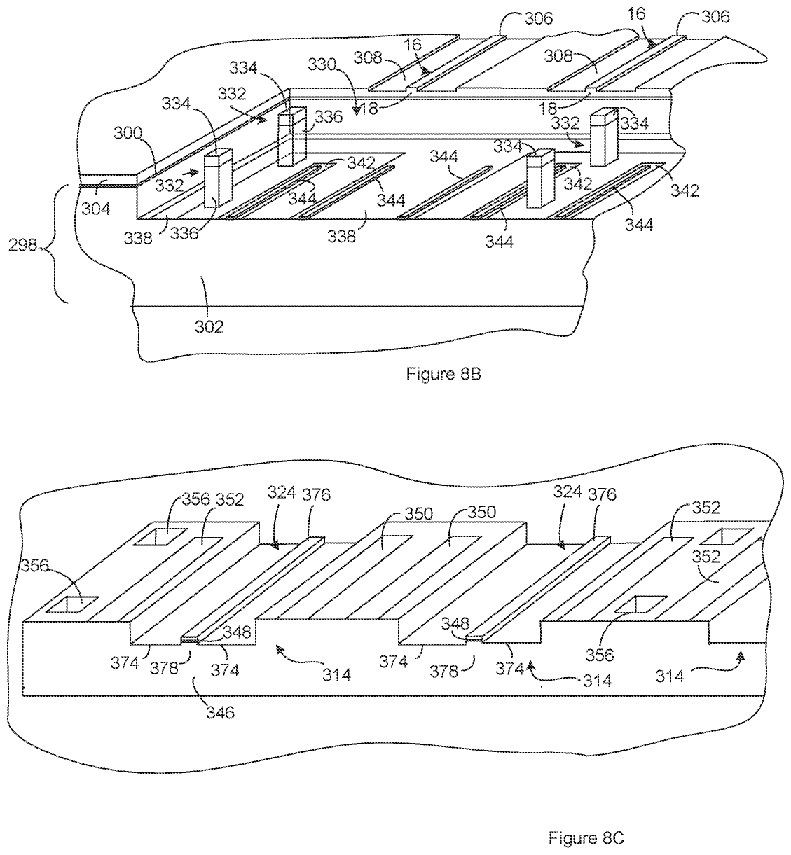

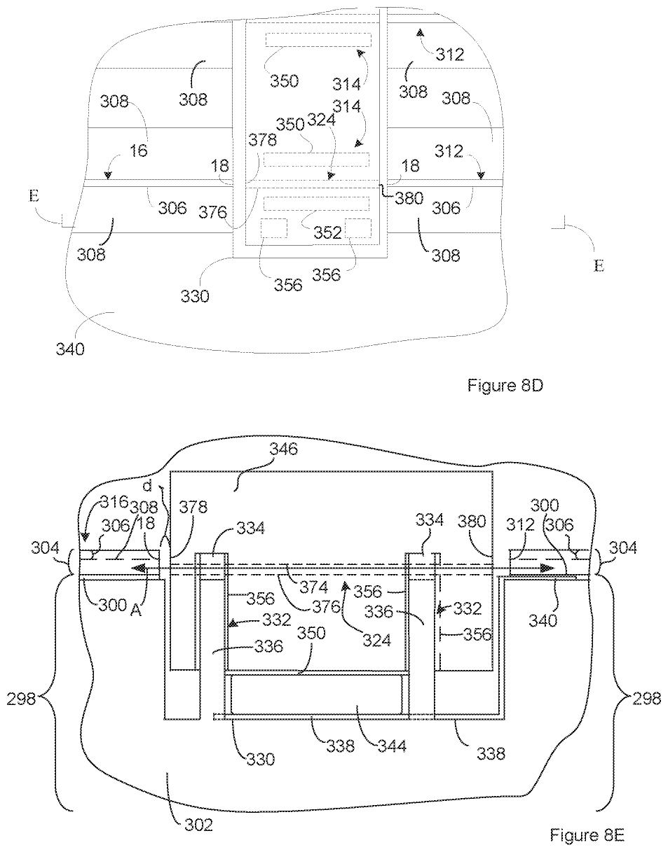

FIG. 8A through FIG. 8E illustrate an example of an interface between an amplifier chip and a LIDAR chip. FIG. 8A is a perspective view of a portion of a LIDAR chip that includes an interface for optically coupling the LIDAR chip with an amplifier chip. FIG. 8B is a perspective view of the portion of a LIDAR chip shown by the dashed lines in FIG. 8A labeled B. The LIDAR chip includes a stop recess 330 sized to receive the amplifier chip. The stop recess 330 extends through the light-transmitting medium 304 and into the base 298. In the illustrated version, the stop recess 330 extends through the light-transmitting medium 304, the buried layer 300, and into the substrate 302.

The facets 18 of the preliminary alternate waveguides 312 and the facets 18 of the alternate waveguides 16 are included in the lateral sides of the stop recess 330. Although not shown, the facets 18 of the preliminary alternate waveguides 312 and the facets 18 of the alternate waveguides 16 can include an anti-reflective coating. A suitable anti-reflective coating includes, but is not limited to, single-layer coatings such as silicon nitride or aluminum oxide, or multi-layer coatings, which may contain silicon nitride, aluminum oxide, and/or silica.

One or more stops 332 extend upward from a bottom of the stop recess 330. For instance, FIG. 8B illustrates four stops 332 extending upward from the bottom of the stop recess 330. The stops 332 include a cladding 334 positioned on a base portion 336. The substrate 302 can serve as the base portion 336 of the stops 332 and the stop 332 can exclude the buried layer 300. The portion of the substrate 302 included in the stops 332 can extend from the bottom of the stop recess 330 up to the level of the buried layer 300. For instance, the stops 332 can be formed by etching through the buried layer 300 and using the underlying substrate 302 as an etch-stop. As a result, the location of the top of the base portion 336 relative to the optical mode of a light signal in an alternate waveguide 16 and/or a preliminary alternate waveguide 312 is well known because the buried layer 300 defines the bottom of the second waveguide and the top of the base portion 336 is located immediately below the buried layer 300. The cladding 334 can be formed on base portion 336 of the stops 332 so as to provide the stops 332 with a height that will provide the desired vertical alignment between each amplifier waveguide 324 on an amplifier chip and one of the alternate waveguides 16 and/or one of the preliminary alternate waveguides 312.

A first electrical conductor 338 extends from a top side of the LIDAR chip, over a lateral side of the stop recess 330 and across a bottom of the stop recess 330. The first electrical conductor 338 can include a contact pad 340 that can be used to provide electrical communication between the electronics and the first electrical conductor 338. Second electrical conductors 342 each extend from a top side of the LIDAR chip, over a lateral side of the stop recess 330 and across a bottom of the stop recess 330. Each of the second electrical conductors 342 can include a contact pad 340 that can be used to provide electrical communication between the electronics and the second electrical conductor 342. Solder 344 is positioned on the first electrical conductor 338 and the second electrical conductors 342.

FIG. 8C is a perspective view of one embodiment of an amplifier chip. The illustrated amplifier chip is within the class of devices known as planar optical devices. The amplifier chip includes an amplifier waveguide 324 defined in a gain medium 346. Suitable gain media include, but are not limited to, InP, InGaAsP, and GaAs.

Trenches 374 extending into the gain medium 346 define a ridge 376 in the gain medium 346. The ridge 376 defines the amplifier waveguide 324. In some instances, the gain medium 346 includes one or more layers 348 in the ridge and/or extending across the ridge 376. The one or more layers 348 can be positioned between different regions of the gain medium 346. The region of the gain medium 346 above the one or more layers 348 can be the same as or different from the region of the gain medium 346 below the one or more layers 348. The layers can be selected to constrain light signals guided through the amplifier waveguide 324 to a particular location relative to the ridge 376. Each of the layers 348 can have a different composition of a material that includes or consists of two or more components selected from a group consisting of In, P, Ga, and As. In one example, the gain medium 346 is InP and the one or more layers 348 each includes Ga and As in different ratios.

The amplifier waveguide 324 provides an optical pathway between a first facet 378 and a second facet 380. Although not shown, the first facet 378 and/or the second facet 380 can optionally include an anti-reflective coating. A suitable anti-reflective coating includes, but is not limited to, single-layer coatings such as silicon nitride or aluminum oxide, or multi-layer coatings that may contain silicon nitride, aluminum oxide, and/or silica.

The amplifier chip includes first amplifier electrical conductors 350 and second amplifier electrical conductors 352. The first amplifier electrical conductors 350 are arranged on the amplifier chip such that the amplifier chip can be inverted and placed in the stop recess 330 with each of the first amplifier electrical conductors 350 aligned with a portion of the first electrical conductor 338 such that solder 344 is positioned between the first amplifier electrical conductors 350 and the first electrical conductor 338 with the solder contacting the first amplifier electrical conductors 350 and the first electrical conductor 338. The second amplifier electrical conductors 352 are arranged on the amplifier chip such that the amplifier chip can be inverted and placed in the stop recess 330 with each of the second amplifier electrical conductors 352 aligned with one of the second electrical conductors 340 such that solder 344 is positioned between the second amplifier electrical conductors 352 and the second electrical conductor 340 and the solder 344 contacts the second amplifier electrical conductors 352 and the second electrical conductor 340.

The amplifier chip also includes one or more alignment recesses 356. Each of the alignment recesses 356 is sized to receive one of the stops 332.

FIG. 8D and FIG. 8E illustrate a LIDAR system that includes the LIDAR chip of FIG. 8A and FIG. 8B interfaced with the amplifier chip of FIG. 8C. The LIDAR chip is inverted and positioned in the stop recess 330. FIG. 8D is a topview of the LIDAR system. FIG. 8E is a sideview of a cross section of the system taken through the alternate waveguide 16 on the LIDAR chip and the amplifier waveguide 324 on the amplifier chip. For instance, the cross section of FIG. 8E can be taken a long a line extending through the brackets labeled E in FIG. 8D. FIG. 8D and FIG. 8E each includes dashed lines that illustrate features that are located behind other features in the system. For instance, FIG. 8D includes dashed lines the show the locations of the ridge 376 of the amplifier waveguide 324, the first amplifier electrical conductors 350, the second amplifier electrical conductors 352 and the alignment recesses 356 under the gain medium 346. Additionally, FIG. 8E includes dashed lines that illustrate the locations of the amplifier waveguide 324 behind the stops 332. FIG. 8E also includes dashed lines that illustrate the location where the ridge 86 of the alternate waveguide 16 interfaces with the slab regions 308 that define the alternate waveguide 16 and dashed lines that illustrate the location where the ridge 376 of the amplifier waveguide 324 interfaces with slab regions 374 of the amplifier chip.

The amplifier chip is positioned in the stop recess 330 on the LIDAR chip. The amplifier chip is positioned such that the ridge 376 of the amplifier waveguide 324 is located between the bottom of the amplifier chip and the base 298 of the LIDAR chip. Accordingly, the amplifier chip is inverted in the stop recess 330. Solder 344 or other electrically conducting adhesive contacts each of the first amplifier electrical conductors 350 and the first electrical conductor 338. Although not shown in FIG. 3E, the solder 344 or other electrically conducting adhesive contacts are arranged such that the solder 344 or other electrically conducting adhesive contacts each of the second amplifier electrical conductors 352 and one of the second electrical conductor 340. The solder 344 or other adhesive 358 can immobilize the amplifier chip relative to the LIDAR chip.

The facet 18 of the alternate waveguide 16 is aligned with the first facet 378 of the amplifier waveguide 324 such that the alternate waveguide 16 and the amplifier waveguide 324 can exchange light signals. Additionally, the facet 18 of the preliminary alternate waveguide 312 is aligned with the second facet 380 of the amplifier waveguide 324 such that the preliminary alternate waveguide 312 and the amplifier waveguide 324 can exchange light signals. As shown by the line labeled A, the system provides a horizontal optical path in that the direction that light signals travel from the LIDAR chip, through the amplifier chip and back into the LIDAR chip is parallel or is substantially parallel relative to an upper and/or lower surface of the base 298. A top of the first facet 378 of the amplifier waveguide 324 is at a level that is below the top of the facet 18 of the alternate waveguide and below the top of the facet 18 of the preliminary alternate waveguide 312.

The one or more stops 332 on the LIDAR chip are each received within one of the alignment recesses 356 on the amplifier chip. The top of each stop 332 contacts the bottom of the alignment recess 356. As a result, the interaction between stops 332 and the bottom of the alignment recesses 356 prevents additional movement of the amplifier chip toward the LIDAR chip. In some instances, the amplifier chip rests on top of the stops 332.

As is evident from FIG. 8E, the first facet 378 of the amplifier waveguide 324 is vertically aligned with the facet 18 of the alternate waveguide 16 on the LIDAR chip and the second facet 380 of the amplifier waveguide 324 is vertically aligned with the facet 18 of the preliminary alternate waveguide 312 on the LIDAR chip. As is evident from FIG. 8D, the first facet 378 of the amplifier waveguide 324 is horizontally aligned with the facet 18 of the alternate waveguide 16 on the LIDAR chip. The horizontal alignment can be achieved by alignment of marks and/or features on the amplifier chip and the LIDAR chip.

The vertical alignment can be achieved by controlling the height of the stops 332 on the LIDAR chip. For instance, the cladding 334 on the base portion 336 of the stops 332 can be grown to the height that places the first facet 378 of the amplifier waveguide 324 at a particular height relative to the facet 18 of the alternate waveguide 16 on the LIDAR chip. The desired cladding 334 thickness can be accurately achieved by using deposition techniques such as evaporation, plasma enhanced chemical vapor deposition (PECVD), and/or sputtering to deposit the one or more cladding layers. As a result, one or more cladding layers can be deposited on the base portion 336 of the stops 332 so as to form the stops 332 to a height that provides the desired vertical alignment. Suitable materials for layers of the cladding 334 include, but are not limited to, silica, silicon nitride, and polymers.

In FIG. 8E, the first facet 378 is spaced apart from the facet 18 by a distance labeled d. The second facet 380 is also spaced apart from the facet 18 by a distance labeled d. The distance “d” can be less than 5 μm, 3 μm, or 1 μm and/or greater than 0.0 μm. In FIG. 8E, the atmosphere in which the LIDAR chip is positioned is located in the gap between the first facet 378 and a facet 18 and also between the second facet 380 and a facet 18; however, other gap materials can be positioned in one or more of these gaps. For instance, a solid gap material can be positioned in the gap. Examples of suitable gap materials include, but are not limited to, epoxies and polymers.

FIG. 8E shows the solder 344 in contact with the first amplifier electrical conductor 350 and the first electrical conductor 338. As a result, the first amplifier electrical conductor 350, the solder 344, and the first electrical conductor 338 can provide electrical communication between a contact pad 340 on the first electrical conductor 338 and the amplifier. Although not illustrated, the second amplifier electrical conductor 352, the solder 344, and the second electrical conductor 342 can provide electrical communication between the contact pad 340 on the second electrical conductor 342 and an amplifier on the amplifier chip. Accordingly, the electronics can independently operate each of the amplifiers on the amplifier chip by applying a bias between contact pad 340 on the first electrical conductor 338 and the contact pad 340 on the second electrical conductor 342 that is associated with the amplifier. The bias can be applied so as to drive an electrical current through the gain medium in the amplifier. During concurrent operation of multiple different amplifiers, the first electrical conductor 338 can act as a common conductor.

An example of a variable optical attenuators suitable for use with a ridge waveguides on a silicon-on-insulator platform can be found in U.S. patent application Ser. An example of a suitable optical attenuator can be found in U.S. patent application Ser. No. 17/396,616, filed on Aug. 6, 2021, entitled “Carrier Injector Having Increased Compatibility,” and incorporated herein in its entirety.

As is evident from FIG. 1A, the LIDAR system can optionally include one or more light signal amplifiers 446 in addition to the amplifiers 314 and any amplifiers 323. For instance, an amplifier 446 can optionally be positioned along a utility waveguide 12 as illustrated in the LIDAR system of FIG. 1A. The electronics can operate the amplifier 446 so as to amplify the power of the outgoing LIDAR signal precursor and accordingly of the resulting system output signal. Suitable amplifiers 446 for use on the LIDAR chip, include, but are not limited to, Semiconductor Optical Amplifiers (SOAs) and SOA arrays.

Light sensors that are interfaced with waveguides on a LIDAR chip can be a component that is separate from the chip and then attached to the chip. For instance, the light sensor can be a photodiode, or an avalanche photodiode. Examples of suitable light sensors include, but are not limited to, InGaAs PIN photodiodes manufactured by Hamamatsu located in Hamamatsu City, Japan, or an InGaAs APD (Avalanche Photo Diode) manufactured by Hamamatsu located in Hamamatsu City, Japan. These light sensors can be centrally located on the LIDAR chip. Alternately, all or a portion the waveguides that terminate at a light sensor can terminate at a facet located at an edge of the chip and the light sensor can be attached to the edge of the chip over the facet such that the light sensor receives light that passes through the facet. The use of light sensors that are a separate component from the chip is suitable for all or a portion of the light sensors selected from the group consisting of the first light sensor and the second light sensor.

As an alternative to a light sensor that is a separate component, all or a portion of the light sensors can be integrated with the chip. For instance, examples of light sensors that are interfaced with ridge waveguides on a chip constructed from a silicon-on-insulator wafer can be found in Optics Express Vol. 15, No. 21, 13965-13971 (2007); U.S. Pat. No. 8,093,080, issued on Jan. 10, 2012; U.S. Pat. No. 8,242,432, issued Aug. 14, 2012; and U.S. Pat. No. 6,108,8472, issued on Aug. 22, 2000 each of which is incorporated herein in its entirety. The use of light sensors that are integrated with the chip are suitable for all or a portion of the light sensors selected from the group consisting of the first light sensor and the second light sensor.

Suitable electronics 32 can include, but are not limited to, a controller that includes or consists of analog electrical circuits, digital electrical circuits, processors, microprocessors, digital signal processors (DSPs), Field Programmable Gate Arrays (FPGAs), computers, microcomputers, or combinations suitable for performing the operation, monitoring and control functions described above. In some instances, the controller has access to a memory that includes instructions to be executed by the controller during performance of the operation, control and monitoring functions. In some instances, the functions of the LIDAR data generator and the peak finder can be executed by Field Programmable Gate Arrays (FPGAs), digital signal processors (DSPs), Application Specific Integrated Circuits, firmware, software, hardware, and combinations thereof. Although the electronics are illustrated as a single component in a single location, the electronics can include multiple different components that are independent of one another and/or placed in different locations. Additionally, as noted above, all or a portion of the disclosed electronics can be included on the chip including electronics that are integrated with the chip.

An example of a suitable selector controller 15 executes the attributed functions using firmware, hardware, or software or a combination thereof. An example of a suitable light source controller 63 executes the attributed functions using firmware, hardware, or software or a combination thereof. An example of a suitable data processor 237 executes the attributed functions using firmware, hardware, or software or a combination thereof. An example of a suitable assembly electronics 280 and electronics 62 executes the attributed functions using firmware, hardware, or software or a combination thereof.

Components on the LIDAR chip can be fully or partially integrated with the LIDAR chip. For instance, the integrated optical components can include or consist of a portion of the wafer from which the LIDAR chip is fabricated. A wafer that can serve as a platform for a LIDAR chip can include multiple layers of material. At least a portion of the different layers can be different materials. As an example, in a silicon-on-insulator wafer that includes the buried layer 300 between the substrate 302 and the light-transmitting medium 304 as shown in FIG. 6, the integrated on-chip components can be formed by using etching and masking techniques to define the features of the component in the light-transmitting medium 304. For instance, the slab regions 308 that define the waveguides and the stop recess can be formed in the desired regions of the wafer using different etches of the wafer. As a result, the LIDAR chip includes a portion of the wafer and the integrated on-chip components can each include or consist of a portion of the wafer. Further, the integrated on-chip components can be configured such that light signals traveling through the component travel through one or more of the layers that were originally included in the wafer. For instance, the waveguide of FIG. 6 guides light signal through the light-transmitting medium 304 from the wafer. The integrated components can optionally include materials in addition to the materials that were present on the wafer. For instance, the integrated components can include reflective materials and/or a cladding.

Although the gain medium is disclosed as having both a laser waveguide and an amplifier waveguide 324, the amplifier waveguide 324 is optional. As a result, the utility waveguide can be continuous with the auxiliary waveguide and/or can serve the auxiliary waveguide.

Numeric labels such as first, second, third, etc. are used to distinguish different features and components and do not indicate sequence or existence of lower numbered features. For instance, a second component can exist without the presence of a first component and/or a third step can be performed before a first step. The light signals disclosed above each include, consist of, or consist essentially of light from the prior light signal(s) from which the light signal is derived. For instance, an incoming LIDAR signal includes, consists of, or consists essentially of light from the LIDAR input signal.

Although the LIDAR system is disclosed as using complex signals such as the complex data signal, the LIDAR system can also use real signals. As a result, the mathematical transform can be a real transform and the components associated with the generation and use of the quadrature components can be removed from the LIDAR system. As a result, the LIDAR system can use a single signal combiner. Additionally, or alternately, a single light sensor can replace each of the balanced detectors.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A system, comprising:
LIDAR system that includes a utility waveguide configured to guide an outgoing LIDAR signal precursor;
the LIDAR system including multiple preliminary alternate waveguides that are each configured to guide a preliminary outgoing LIDAR signal, each of the preliminary outgoing LIDAR signals including light from the outgoing LIDAR signal precursor;
the LIDAR system including amplifiers, each of the amplifiers being configured to receive one of the preliminary outgoing LIDAR signals from a different one of the preliminary alternate waveguides, each of the amplifiers configured to output an outgoing LIDAR signal that includes light from one of the preliminary outgoing LIDAR signal received by the amplifier; and
the LIDAR system including multiple alternate waveguides that are each configured to receive one of the outgoing LIDAR signals from a different one of the amplifiers;
electronics configured to operate the amplifiers such that one of the amplifiers serve as an active amplifier and one or more of the amplifiers each serves as inactive amplifier, the outgoing LIDAR signal output from the active amplifier being an active outgoing LIDAR signal and any outgoing LIDAR signal output from one of the inactive amplifiers being an inactive outgoing LIDAR signal;
the LIDAR system being configured to use light output from the active outgoing LIDAR signal to calculate LIDAR data but not using light output from the inactive amplifiers to calculate any LIDAR data, the LIDAR data indicating a distance and/or radial velocity between the LIDAR system and an object.

2. The system of claim 1, wherein the LIDAR system is configured to transmit a system output signal that includes light from the active outgoing LIDAR signal.

3. The system of claim 2, wherein a direction that the system output signal travels away from the LIDAR system changes in response to a change in the amplifier that serves as the active amplifier.

4. The system of claim 2, wherein the LIDAR system uses light from the active outgoing LIDAR signal to calculate the LIDAR data.

5. The system of claim 2, wherein the system output signal carries multiple different wavelength channels and a direction that the system output signal travels away from the LIDAR system changes in response to a change in the wavelength channel carried by the system output signal.

6. The system of claim 1, wherein the LIDAR system is configured to change the amplifier that serves as the active amplifier.

7. The system of claim 1, wherein each of the amplifiers that does not serve as the active amplifier serves as one of the inactive amplifiers.

8. The system of claim 1, wherein LIDAR system operates the active amplifier such that a power level of the active outgoing LIDAR signal is more than 1000 times a power level of any inactive outgoing LIDAR signal output from one of the inactive amplifiers.

9. The system of claim 1, wherein LIDAR system operates each of the inactive amplifiers such that a power level of the preliminary outgoing LIDAR signal received by the inactive amplifier is more than 10 times a power level of the outgoing LIDAR signal output from the inactive amplifier.

10. The system of claim 1, wherein the LIDAR system applies a reverse bias to least one of the inactive amplifiers.

11. The system of claim 1, wherein the LIDAR system operates the amplifiers such that at least one of the inactive amplifiers does not output an inactive outgoing LIDAR signal.

12. The system of claim 1, wherein each of the amplifiers is a Semiconductor Optical Amplifier (SOA).

13. The system of claim 1, wherein the LIDAR system includes a semiconductor chip that includes the utility waveguide, preliminary alternate waveguides, amplifiers, and alternate waveguides.

14. The system of claim 1, wherein the LIDAR system includes a splitter configured to receive the outgoing LIDAR signal precursor from the utility waveguide and to split the outgoing LIDAR signal precursor into the preliminary outgoing LIDAR signals received at the preliminary alternate waveguides.

15. The system of claim 1, wherein the splitter is a wavelength independent splitter.

16. A system, comprising:
LIDAR system that includes a utility waveguide configured to guide an outgoing LIDAR signal precursor;
the LIDAR system including multiple preliminary alternate waveguides that are each configured to guide a preliminary outgoing LIDAR signal, each of the preliminary outgoing LIDAR signals including light from the outgoing LIDAR signal precursor;
the LIDAR system including amplifiers, each of the amplifiers being configured to receive one of the preliminary outgoing LIDAR signals from a different one of the preliminary alternate waveguides, each of the amplifiers configured to output an outgoing LIDAR signal that includes light from one of the preliminary outgoing LIDAR signal received by the amplifier; and
the LIDAR system including multiple alternate waveguides that are each configured to receive one of the outgoing LIDAR signals from a different one of the amplifiers;
electronics configured to operate the amplifiers such that one of the amplifiers serve as an active amplifier and one or more of the amplifiers each serves as inactive amplifier, the outgoing LIDAR signal output from the active amplifier being an active outgoing LIDAR signal and any outgoing LIDAR signal output from one of the inactive amplifiers being an inactive outgoing LIDAR signal; and
the LIDAR system being configured to transmit a system output signal that includes light from the active outgoing LIDAR signal,
a direction that the system output signal travels away from the LIDAR system changing in response to a change in the amplifier that serves as the active amplifier.

17. A method of operating a LIDAR system, comprising:
splitting an outgoing LIDAR signal precursor into preliminary outgoing LIDAR signals;
receiving the preliminary outgoing LIDAR signals at amplifiers and outputting from each of the amplifiers an outgoing LIDAR signal, each of the outgoing LIDAR signals including light from a different one of the preliminary outgoing LIDAR signals;
operating the amplifiers such that one of the amplifiers serve as an active amplifier and a portion of the amplifiers each serves as inactive amplifier, the outgoing LIDAR signal output from the active amplifier being an active outgoing LIDAR signal and any outgoing LIDAR signal output from one of the inactive amplifiers being an inactive outgoing LIDAR signal; and
using light output from the active outgoing LIDAR signal to calculate LIDAR data but not using light output from the inactive amplifiers to calculate any LIDAR data, the LIDAR data indicating a distance and/or radial velocity between the LIDAR system and an object.
